(19) United States
(12) Patent Application Publication
(10) Pub. No.: US 2023/0299905 A1
(43) Pub. Date: Sep. 21, 2023

(54) PHASE-TRACKING REFERENCE SIGNAL ALIGNMENT FOR PHYSICAL SHARED CHANNEL

(71) Applicant: QUALCOMM INCORPORATED, San Diego, CA (US)

(72) Inventors: Fang YUAN, Beijing (CN); Mostafa KHOSHNEVISAN, San Diego, CA (US); Wooseok NAM, San Diego, CA (US); Tao LUO, San Diego, CA (US)

(21) Appl. No.: 17/997,650

(22) PCT Filed: Jun. 17, 2020
(86) PCT No.: PCT/CN2020/096473

§ 371 Date: Oct. 31, 2022

(51) Int. Cl. H04L 5/00; H04W 72/1268

(52) U.S. Cl. CPC H04L 5/0048; H04W 72/1268

(57) ABSTRACT

Methods, systems, and devices for wireless communications are described. A communication device, for example a user equipment (UE), may determine that one or more resource elements associated with a phase-tracking reference signal (PRTS) transmission on a first scheduled physical uplink shared channel (PUSCH) are multiplexed with one or more resource elements associated with a data transmission on a second scheduled PUSCH. The UE may puncture the one or more resource elements associated with the data transmission on the second scheduled PUSCH and transmit the PTRS transmission on the first scheduled PUSCH based on puncturing the one or more resource elements associated with the data transmission on the second scheduled PUSCH. Alternatively, the UE may rate match the one or more resources associated with the PTRS transmission around one or more additional resources and transmit the PTRS transmission on the scheduled first PUSCH.

### CROSS REFERENCE

The present Application is a 371 national stage filing of International PCT Application No. PCT/CN2020/096473 by YUAN et al. entitled “PHASE-TRACKING REFERENCE SIGNAL ALIGNMENT FOR PHYSICAL SHARED CHANNEL,” filed Jun. 17, 2020, which is assigned to the assignee hereof, and which is expressly incorporated by reference in its entirety herein.

### TECHNICAL FIELD

The following relates generally to wireless communications and more specifically to phase-tracking reference signal (PTRS) alignment for a physical shared channel.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). Some wireless communication systems may experience high levels of wireless communications traffic due to an increase in demand for a wide range of broadband applications and services by the communication devices. Some wireless communication systems may support millimeter wave radio frequency spectrum bands, which can offer larger bandwidth to the communication devices to boost wireless communications traffic capacity. Operating in the millimeter radio frequency spectrum bands, however, may result in a phase-noise factor (for example, a fluctuation in the phase of a waveform that adversely affects a signal), which may negatively impact performance for the communication devices.

### SUMMARY

Various aspects of the described techniques relate to configuring a wireless communication device, which may be otherwise known as user equipment (UE), to support phase-tracking reference signal (PTRS) alignment, such as for fifth generation (5G) New Radio (NR) systems. In some examples, the described techniques may include configuring the UE to determine that one or multiple time and frequency resources associated with a phase-tracking reference signal (PTRS) transmission on a scheduled physical uplink shared channel (PUSCH) are multiplexed with one or multiple time and frequency resources associated with a data transmission on another scheduled PUSCH. The UE may be configured to puncture the one or multiple time and frequency resources associated with the data transmission on the other scheduled PUSCH and transmit the PTRS transmission on the scheduled PUSCH. Alternatively, the UE may be configured to rate match the one or multiple time and frequency resources associated with the PTRS transmission around one or more additional resources to power boost the PTRS transmission on the scheduled PUSCH. The described techniques may, as a result, include features for improvements to UE operations and, in some examples, may promote high reliability and low latency PTRS transmissions, among other benefits.

A method for wireless communication at a user equipment (UE) is described. The method may include determining that one or more resource elements associated with a phase tracking reference signal transmission on a first scheduled physical uplink shared channel are multiplexed with one or more resource elements associated with a data transmission on a second scheduled physical uplink shared channel, puncturing the one or more resource elements associated with the data transmission on the second scheduled physical uplink shared channel based on the determining, and transmitting the phase tracking reference signal transmission on the first scheduled physical uplink shared channel based on puncturing the one or more resource elements associated with the data transmission on the second scheduled physical uplink shared channel.

An apparatus for wireless communication at a UE is described. The apparatus may include a processor, memory coupled with the processor, and instructions stored in the memory. The instructions may be executable by the processor to cause the apparatus to determine that one or more resource elements associated with a phase tracking reference signal transmission on a first scheduled physical uplink shared channel are multiplexed with one or more resource elements associated with a data transmission on a second scheduled physical uplink shared channel, puncture the one or more resource elements associated with the data transmission on the second scheduled physical uplink shared channel based on the determining, and transmit the phase tracking reference signal transmission on the first scheduled physical uplink shared channel based on puncturing the one or more resource elements associated with the data transmission on the second scheduled physical uplink shared channel.

Another apparatus for wireless communication at a UE is described. The apparatus may include means for determining that one or more resource elements associated with a phase tracking reference signal transmission on a first scheduled physical uplink shared channel are multiplexed with one or more resource elements associated with a data transmission on a second scheduled physical uplink shared channel, means for puncturing the one or more resource elements associated with the data transmission on the second scheduled physical uplink shared channel based on the determining, and means for transmitting the phase tracking reference signal transmission on the first scheduled physical uplink shared channel based on puncturing the one or more resource elements associated with the data transmission on the second scheduled physical uplink shared channel.

A non-transitory computer-readable medium storing code for wireless communication at a UE is described. The code may include instructions executable by a processor to determine that one or more resource elements associated with a phase tracking reference signal transmission on a first scheduled physical uplink shared channel are multiplexed with one or more resource elements associated with a data transmission on a second scheduled physical uplink shared channel, puncture the one or more resource elements associated with the data transmission on the second scheduled physical uplink shared channel based on the determining, and transmit the phase tracking reference signal transmission on the first scheduled physical uplink shared channel based on puncturing the one or more resource elements associated with the data transmission on the second scheduled physical uplink shared channel.

Some examples of the method, apparatuses, and non-transitory computer-readable medium described herein may further include operations, features, means, or instructions for receiving a radio resource control configuration message including an indication to puncture the one or more resource elements associated with the data transmission on the second scheduled physical uplink shared channel, where puncturing the one or more resource elements associated with the data transmission on the second scheduled physical uplink shared channel may be based on the received radio resource control configuration message.

A method is described. The method may include determining a UE capability to puncture the one or more resource elements associated with the data transmission on the second scheduled physical uplink shared channel and transmitting UE capability information including an indication of the UE capability to puncture the one or more resource elements associated with the data transmission on the second scheduled physical uplink shared channel, where puncturing the one or more resource elements associated with the data transmission on the second scheduled physical uplink shared channel is based on the transmitted UE capability information.

An apparatus is described. The apparatus may include a processor, memory coupled with the processor, and instructions stored in the memory. The instructions may be executable by the processor to cause the apparatus to determine a UE capability to puncture the one or more resource elements associated with the data transmission on the second scheduled physical uplink shared channel and transmit UE capability information including an indication of the UE capability to puncture the one or more resource elements associated with the data transmission on the second scheduled physical uplink shared channel, where puncturing the one or more resource elements associated with the data transmission on the second scheduled physical uplink shared channel is based on the transmitted UE capability information.

Another apparatus is described. The apparatus may include means for determining a UE capability to puncture the one or more resource elements associated with the data transmission on the second scheduled physical uplink shared channel and means for transmitting UE capability information including an indication of the UE capability to puncture the one or more resource elements associated with the data transmission on the second scheduled physical uplink shared channel, where puncturing the one or more resource elements associated with the data transmission on the second scheduled physical uplink shared channel is based on the transmitted UE capability information.

A non-transitory computer-readable medium storing code is described. The code may include instructions executable by a processor to determine a UE capability to puncture the one or more resource elements associated with the data transmission on the second scheduled physical uplink shared channel and transmit UE capability information including an indication of the UE capability to puncture the one or more resource elements associated with the data transmission on the second scheduled physical uplink shared channel, where puncturing the one or more resource elements associated with the data transmission on the second scheduled physical uplink shared channel is based on the transmitted UE capability information.

A method is described. The method may include determining a phase tracking reference signal density associated with the first scheduled physical uplink shared channel and determining that the phase tracking reference signal density associated with the first scheduled physical uplink shared channel satisfies a threshold, where puncturing the one or more resource elements associated with the data transmission on the second scheduled physical uplink shared channel is based on determining that the phase tracking reference signal density associated with the first scheduled physical uplink shared channel satisfies the threshold.

An apparatus is described. The apparatus may include a processor, memory coupled with the processor, and instructions stored in the memory. The instructions may be executable by the processor to cause the apparatus to determine a phase tracking reference signal density associated with the first scheduled physical uplink shared channel and determine that the phase tracking reference signal density associated with the first scheduled physical uplink shared channel satisfies a threshold, where puncturing the one or more resource elements associated with the data transmission on the second scheduled physical uplink shared channel is based on determining that the phase tracking reference signal density associated with the first scheduled physical uplink shared channel satisfies the threshold.

Another apparatus is described. The apparatus may include means for determining a phase tracking reference signal density associated with the first scheduled physical uplink shared channel and means for determining that the phase tracking reference signal density associated with the first scheduled physical uplink shared channel satisfies a threshold, where puncturing the one or more resource elements associated with the data transmission on the second scheduled physical uplink shared channel is based on determining that the phase tracking reference signal density associated with the first scheduled physical uplink shared channel satisfies the threshold.

A non-transitory computer-readable medium storing code is described. The code may include instructions executable by a processor to determine a phase tracking reference signal density associated with the first scheduled physical uplink shared channel and determine that the phase tracking reference signal density associated with the first scheduled physical uplink shared channel satisfies a threshold, where puncturing the one or more resource elements associated with the data transmission on the second scheduled physical uplink shared channel is based on determining that the phase tracking reference signal density associated with the first scheduled physical uplink shared channel satisfies the threshold.

Some examples of the method, apparatuses, and non-transitory computer-readable medium described herein may further include operations, features, means, or instructions for determining the phase tracking reference signal density includes determining the phase tracking reference signal density associated with the first scheduled physical uplink shared channel in a time domain or a frequency domain, or both.

Some examples of the method, apparatuses, and non-transitory computer-readable medium described herein may further include operations, features, means, or instructions for puncturing the one or more resource elements associated with the data transmission on the second scheduled physical uplink shared channel may be based on determining that the phase tracking reference signal density in the time domain or the frequency domain, or both, may be greater than the threshold.

Some examples of the method, apparatuses, and non-transitory computer-readable medium described herein may further include operations, features, means, or instructions for puncturing the one or more resource elements associated with the data transmission on the second scheduled physical uplink shared channel may be based on determining that the phase tracking reference signal density in the time domain or the frequency domain, or both, may be less than the threshold.

A method is described. The method may include puncturing the one or more resource elements associated with the data transmission on the second scheduled physical uplink shared channel is based on the first scheduled physical uplink shared channel partially overlapping the second scheduled physical uplink shared channel.

An apparatus is described. The apparatus may include a processor, memory coupled with the processor, and instructions stored in the memory. The instructions may be executable by the processor to cause the apparatus to puncture the one or more resource elements associated with the data transmission on the second scheduled physical uplink shared channel is based on the first scheduled physical uplink shared channel partially overlapping the second scheduled physical uplink shared channel.

Another apparatus is described. The apparatus may include means for puncturing the one or more resource elements associated with the data transmission on the second scheduled physical uplink shared channel is based on the first scheduled physical uplink shared channel partially overlapping the second scheduled physical uplink shared channel.

A non-transitory computer-readable medium storing code is described. The code may include instructions executable by a processor to puncture the one or more resource elements associated with the data transmission on the second scheduled physical uplink shared channel is based on the first scheduled physical uplink shared channel partially overlapping the second scheduled physical uplink shared channel.

A method for wireless communication at a base station is described. The method may include transmitting, to a UE a message including an indication to puncture one or more resource elements associated with a data transmission on a second scheduled physical uplink shared channel based on one or more resource elements associated with a phase tracking reference signal transmission on a first scheduled physical uplink shared channel being multiplexed with the one or more resource elements associated with the data transmission on the second scheduled physical uplink shared channel and receiving the phase tracking reference signal transmission on the first scheduled physical uplink shared channel based on transmitting the message and the UE puncturing the one or more resource elements associated with the data transmission on the second scheduled physical uplink shared channel.

An apparatus for wireless communication at a base station is described. The apparatus may include a processor, memory coupled with the processor, and instructions stored in the memory. The instructions may be executable by the processor to cause the apparatus to transmit, to a UE a message including an indication to puncture one or more resource elements associated with a data transmission on a second scheduled physical uplink shared channel based on one or more resource elements associated with a phase tracking reference signal transmission on a first scheduled physical uplink shared channel being multiplexed with the one or more resource elements associated with the data transmission on the second scheduled physical uplink shared channel and receive the phase tracking reference signal transmission on the first scheduled physical uplink shared channel based on transmitting the message and the UE puncturing the one or more resource elements associated with the data transmission on the second scheduled physical uplink shared channel.

Another apparatus for wireless communication at a base station is described. The apparatus may include means for transmitting, to a UE a message including an indication to puncture one or more resource elements associated with a data transmission on a second scheduled physical uplink shared channel based on one or more resource elements associated with a phase tracking reference signal transmission on a first scheduled physical uplink shared channel being multiplexed with the one or more resource elements associated with the data transmission on the second scheduled physical uplink shared channel and means for receiving the phase tracking reference signal transmission on the first scheduled physical uplink shared channel based on transmitting the message and the UE puncturing the one or more resource elements associated with the data transmission on the second scheduled physical uplink shared channel.

A non-transitory computer-readable medium storing code for wireless communication at a base station is described. The code may include instructions executable by a processor to transmit, to a UE a message including an indication to puncture one or more resource elements associated with a data transmission on a second scheduled physical uplink shared channel based on one or more resource elements associated with a phase tracking reference signal transmission on a first scheduled physical uplink shared channel being multiplexed with the one or more resource elements associated with the data transmission on the second scheduled physical uplink shared channel and receive the phase tracking reference signal transmission on the first scheduled physical uplink shared channel based on transmitting the message and the UE puncturing the one or more resource elements associated with the data transmission on the second scheduled physical uplink shared channel.

Some examples of the method, apparatuses, and non-transitory computer-readable medium described herein may further include operations, features, means, or instructions for transmitting the message includes transmitting a radio resource control configuration message including an indication to puncture the one or more resource elements associated with the data transmission on the second scheduled physical uplink shared channel.

A method is described. The method may include transmitting the message includes transmitting a downlink control information message including an indication to puncture the one or more resource elements associated with the data transmission on the second scheduled physical uplink shared channel.

An apparatus is described. The apparatus may include a processor, memory coupled with the processor, and instructions stored in the memory. The instructions may be executable by the processor to cause the apparatus to transmit the message includes transmitting a downlink control information message including an indication to puncture the one or more resource elements associated with the data transmission on the second scheduled physical uplink shared channel.

Another apparatus is described. The apparatus may include means for transmitting the message includes transmitting a downlink control information message including an indication to puncture the one or more resource elements associated with the data transmission on the second scheduled physical uplink shared channel.

A non-transitory computer-readable medium storing code is described. The code may include instructions executable by a processor to transmit the message includes transmitting a downlink control information message including an indication to puncture the one or more resource elements associated with the data transmission on the second scheduled physical uplink shared channel.

A method is described. The method may include transmitting the message is based on the received UE capability information.

An apparatus is described. The apparatus may include a processor, memory coupled with the processor, and instructions stored in the memory. The instructions may be executable by the processor to cause the apparatus to transmit the message is based on the received UE capability information.

Another apparatus is described. The apparatus may include means for transmitting the message is based on the received UE capability information.

A non-transitory computer-readable medium storing code is described. The code may include instructions executable by a processor to transmit the message is based on the received UE capability information.

A method for wireless communication at a UE is described. The method may include determining one or more resources associated with a phase tracking reference signal transmission on a scheduled physical uplink shared channel, receiving an indication to rate match the one or more resources associated with the phase tracking reference signal transmission, rate matching the one or more resources associated with the phase tracking reference signal transmission around one or more additional resources based on the indication, and transmitting the phase tracking reference signal transmission on the scheduled physical uplink shared channel based on the rate matching.

An apparatus for wireless communication at a UE is described. The apparatus may include a processor, memory coupled with the processor, and instructions stored in the memory. The instructions may be executable by the processor to cause the apparatus to determine one or more resources associated with a phase tracking reference signal transmission on a scheduled physical uplink shared channel, receive an indication to rate match the one or more resources associated with the phase tracking reference signal transmission, rate match the one or more resources associated with the phase tracking reference signal transmission around one or more additional resources based on the indication, and transmit the phase tracking reference signal transmission on the scheduled physical uplink shared channel based on the rate matching.

Another apparatus for wireless communication at a UE is described. The apparatus may include means for determining one or more resources associated with a phase tracking reference signal transmission on a scheduled physical uplink shared channel, means for receiving an indication to rate match the one or more resources associated with the phase tracking reference signal transmission, means for rate matching the one or more resources associated with the phase tracking reference signal transmission around one or more additional resources based on the indication, and means for transmitting the phase tracking reference signal transmission on the scheduled physical uplink shared channel based on the rate matching.

A non-transitory computer-readable medium storing code for wireless communication at a UE is described. The code may include instructions executable by a processor to determine one or more resources associated with a phase tracking reference signal transmission on a scheduled physical uplink shared channel, receive an indication to rate match the one or more resources associated with the phase tracking reference signal transmission, rate match the one or more resources associated with the phase tracking reference signal transmission around one or more additional resources based on the indication, and transmit the phase tracking reference signal transmission on the scheduled physical uplink shared channel based on the rate matching.

Some examples of the method, apparatuses, and non-transitory computer-readable medium described herein may further include operations, features, means, or instructions for receiving the indication includes receiving a radio resource control configuration message including the indication to rate match the one or more resources associated with the phase tracking reference signal transmission and rate matching the one or more resources associated with the phase tracking reference signal transmission may be based on the received radio resource control configuration message.

In some examples of the method, apparatuses, and non-transitory computer-readable medium described herein, rate matching the one or more resources associated with the phase tracking reference signal transmission may be based on at least one phase tracking reference signal transmission pattern of the set of phase tracking reference signal transmission patterns.

A method is described. The method may include receiving the indication includes receiving a downlink control information message including the indication to rate match the one or more resources associated with the phase tracking reference signal transmission and rate matching the one or more resources associated with the phase tracking reference signal transmission is based on the received downlink control information message.

An apparatus is described. The apparatus may include a processor, memory coupled with the processor, and instructions stored in the memory. The instructions may be executable by the processor to cause the apparatus to receive the indication includes receiving a downlink control information message including the indication to rate match the one or more resources associated with the phase tracking reference signal transmission and rate match the one or more resources associated with the phase tracking reference signal transmission is based on the received downlink control information message.

Another apparatus is described. The apparatus may include means for receiving the indication includes receiving a downlink control information message including the indication to rate match the one or more resources associated with the phase tracking reference signal transmission and means for rate matching the one or more resources associated with the phase tracking reference signal transmission is based on the received downlink control information message.

A non-transitory computer-readable medium storing code is described. The code may include instructions executable by a processor to receive the indication includes receiving a downlink control information message including the indication to rate match the one or more resources associated with the phase tracking reference signal transmission and rate match the one or more resources associated with the phase tracking reference signal transmission is based on the received downlink control information message.

In some examples of the method, apparatuses, and non-transitory computer-readable medium described herein, rate matching the one or more resources associated with the phase tracking reference signal transmission may be based on the selected phase tracking reference signal transmission pattern of the set of phase tracking reference signal transmission patterns.

In some examples of the method, apparatuses, and non-transitory computer-readable medium described herein, rate matching the one or more resources associated with the phase tracking reference signal transmission may be based on one or more of the phase tracking reference signal transmission density, the offset of the one or more resources associated with the phase tracking reference signal transmission, or the location of the one or more resources associated with the phase tracking reference signal transmission.

In some examples of the method, apparatuses, and non-transitory computer-readable medium described herein, rate matching the one or more resources associated with the phase tracking reference signal transmission may be based on the one or more antenna ports associated with the phase tracking reference signal transmission.

A method is described. The method may include.

An apparatus is described. The apparatus may include a processor, memory coupled with the processor, and instructions stored in the memory. The instructions may be executable by the processor to cause the apparatus to.

Another apparatus is described. The apparatus may include.

A non-transitory computer-readable medium storing code is described. The code may include instructions executable by a processor to.

In some examples of the method, apparatuses, and non-transitory computer-readable medium described herein, power boosting the phase tracking reference signal transmission on the scheduled physical uplink shared channel may be based on determining to refrain from the second phase tracking reference signal transmission on the scheduled physical uplink shared channel.

A method is described. The method may include the one or more resources include one or more of resource elements, resource blocks, symbols, or slots.

An apparatus is described. The apparatus may include a processor, memory coupled with the processor, and instructions stored in the memory. The instructions may be executable by the processor to cause the apparatus to the one or more resources include one or more of resource elements, resource blocks, symbols, or slots.

Another apparatus is described. The apparatus may include means for the one or more resources include one or more of resource elements, resource blocks, symbols, or slots.

A non-transitory computer-readable medium storing code is described. The code may include instructions executable by a processor to the one or more resources include one or more of resource elements, resource blocks, symbols, or slots.

A method is described. The method may include the one or more resources include one or more periodic resources.

An apparatus is described. The apparatus may include a processor, memory coupled with the processor, and instructions stored in the memory. The instructions may be executable by the processor to cause the apparatus to the one or more resources include one or more periodic resources.

Another apparatus is described. The apparatus may include means for the one or more resources include one or more periodic resources.

A non-transitory computer-readable medium storing code is described. The code may include instructions executable by a processor to the one or more resources include one or more periodic resources.

A method for wireless communication at a base station is described. The method may include transmitting, to a UE, a message including an indication to rate match one or more resources associated with a phase tracking reference signal transmission on a scheduled physical uplink shared channel around one or more additional resources and receiving the phase tracking reference signal transmission on the scheduled physical uplink shared channel based on transmitting the message and the UE rate matching the one or more resources associated with the phase tracking reference signal transmission around the one or more additional resources.

An apparatus for wireless communication at a base station is described. The apparatus may include a processor, memory coupled with the processor, and instructions stored in the memory. The instructions may be executable by the processor to cause the apparatus to transmit, to a UE, a message including an indication to rate match one or more resources associated with a phase tracking reference signal transmission on a scheduled physical uplink shared channel around one or more additional resources and receive the phase tracking reference signal transmission on the scheduled physical uplink shared channel based on transmitting the message and the UE rate matching the one or more resources associated with the phase tracking reference signal transmission around the one or more additional resources.

Another apparatus for wireless communication at a base station is described. The apparatus may include means for transmitting, to a UE, a message including an indication to rate match one or more resources associated with a phase tracking reference signal transmission on a scheduled physical uplink shared channel around one or more additional resources and means for receiving the phase tracking reference signal transmission on the scheduled physical uplink shared channel based on transmitting the message and the UE rate matching the one or more resources associated with the phase tracking reference signal transmission around the one or more additional resources.

A non-transitory computer-readable medium storing code for wireless communication at a base station is described. The code may include instructions executable by a processor to transmit, to a UE, a message including an indication to rate match one or more resources associated with a phase tracking reference signal transmission on a scheduled physical uplink shared channel around one or more additional resources and receive the phase tracking reference signal transmission on the scheduled physical uplink shared channel based on transmitting the message and the UE rate matching the one or more resources associated with the phase tracking reference signal transmission around the one or more additional resources.

Some examples of the method, apparatuses, and non-transitory computer-readable medium described herein may further include operations, features, means, or instructions for transmitting the message includes transmitting a radio resource control configuration message including the indication to rate match the one or more resources associated with the phase tracking reference signal transmission.

In some examples of the method, apparatuses, and non-transitory computer-readable medium described herein, the transmitted radio resource control configuration message includes a set of phase tracking reference signal transmission patterns.

A method is described. The method may include transmitting the message includes transmitting a downlink control information message including the indication to rate match the one or more resources associated with the phase tracking reference signal transmission.

An apparatus is described. The apparatus may include a processor, memory coupled with the processor, and instructions stored in the memory. The instructions may be executable by the processor to cause the apparatus to transmit the message includes transmitting a downlink control information message including the indication to rate match the one or more resources associated with the phase tracking reference signal transmission.

Another apparatus is described. The apparatus may include means for transmitting the message includes transmitting a downlink control information message including the indication to rate match the one or more resources associated with the phase tracking reference signal transmission.

A non-transitory computer-readable medium storing code is described. The code may include instructions executable by a processor to transmit the message includes transmitting a downlink control information message including the indication to rate match the one or more resources associated with the phase tracking reference signal transmission.

In some examples of the method, apparatuses, and non-transitory computer-readable medium described herein, the transmitted downlink control information message includes a set of phase tracking reference signal transmission patterns.

In some examples of the method, apparatuses, and non-transitory computer-readable medium described herein, at least one phase tracking reference signal transmission pattern of a set of phase tracking reference signal transmission patterns includes one or more of a phase tracking reference signal transmission density, an offset of the one or more resources associated with the phase tracking reference signal transmission, or a location of the one or more resources associated with the phase tracking reference signal transmission.

A method is described. The method may include the indication includes a rate match indicator, a zero-power reference signal indicator, or a reference signal port indicator.

An apparatus is described. The apparatus may include a processor, memory coupled with the processor, and instructions stored in the memory. The instructions may be executable by the processor to cause the apparatus to the indication include a rate match indicator, a zero-power reference signal indicator, or a reference signal port indicator.

Another apparatus is described. The apparatus may include means for the indication includes a rate match indicator, a zero-power reference signal indicator, or a reference signal port indicator.

A non-transitory computer-readable medium storing code is described. The code may include instructions executable by a processor to the indication include a rate match indicator, a zero-power reference signal indicator, or a reference signal port indicator.

A method is described. The method may include the one or more resources include one or more of resource elements, resource blocks, symbols, or slots.

An apparatus is described. The apparatus may include a processor, memory coupled with the processor, and instructions stored in the memory. The instructions may be executable by the processor to cause the apparatus to the one or more resources include one or more of resource elements, resource blocks, symbols, or slots.

Another apparatus is described. The apparatus may include means for the one or more resources include one or more of resource elements, resource blocks, symbols, or slots.

A non-transitory computer-readable medium storing code is described. The code may include instructions executable by a processor to the one or more resources include one or more of resource elements, resource blocks, symbols, or slots.

A method is described. The method may include determine a phase tracking reference signal density associated with the first scheduled physical uplink shared channel and determine that the phase tracking reference signal density associated with the first scheduled physical uplink shared channel satisfies a threshold, where puncturing the one or more resource elements associated with the data transmission on the second scheduled physical uplink shared channel is based on determining that the phase tracking reference signal density associated with the first scheduled physical uplink shared channel satisfies the threshold.

An apparatus is described. The apparatus may include a processor, memory coupled with the processor, and instructions stored in the memory. The instructions may be executable by the processor to cause the apparatus to determine a phase tracking reference signal density associated with the first scheduled physical uplink shared channel and determine that the phase tracking reference signal density associated with the first scheduled physical uplink shared channel satisfies a threshold, where puncturing the one or more resource elements associated with the data transmission on the second scheduled physical uplink shared channel is based on determining that the phase tracking reference signal density associated with the first scheduled physical uplink shared channel satisfies the threshold.

Another apparatus is described. The apparatus may include means for determine a phase tracking reference signal density associated with the first scheduled physical uplink shared channel and means for determine that the phase tracking reference signal density associated with the first scheduled physical uplink shared channel satisfies a threshold, where puncturing the one or more resource elements associated with the data transmission on the second scheduled physical uplink shared channel is based on determining that the phase tracking reference signal density associated with the first scheduled physical uplink shared channel satisfies the threshold.

A non-transitory computer-readable medium storing code is described. The code may include instructions executable by a processor to determine a phase tracking reference signal density associated with the first scheduled physical uplink shared channel and determine that the phase tracking reference signal density associated with the first scheduled physical uplink shared channel satisfies a threshold, where puncturing the one or more resource elements associated with the data transmission on the second scheduled physical uplink shared channel is based on determining that the phase tracking reference signal density associated with the first scheduled physical uplink shared channel satisfies the threshold.

In some examples of the method, apparatuses, and non-transitory computer-readable medium described herein, the instructions to determine the phase tracking reference signal density may be executable by the processor to cause the apparatus to determine the phase tracking reference signal density associated with the first scheduled physical uplink shared channel in a time domain or a frequency domain, or both.

In some examples of the method, apparatuses, and non-transitory computer-readable medium described herein, the instructions may be further executable by the processor to cause the apparatus to determine that the phase tracking reference signal density in the time domain or the frequency domain, or both, may be greater than the threshold and puncturing the one or more resource elements associated with the data transmission on the second scheduled physical uplink shared channel may be based on determining that the phase tracking reference signal density in the time domain or the frequency domain, or both, may be greater than the threshold.

In some examples of the method, apparatuses, and non-transitory computer-readable medium described herein, the instructions may be further executable by the processor to cause the apparatus to determine that the phase tracking reference signal density in the time domain or the frequency domain, or both, may be less than the threshold and puncturing the one or more resource elements associated with the data transmission on the second scheduled physical uplink shared channel may be based on determining that the phase tracking reference signal density in the time domain or the frequency domain, or both, may be less than the threshold.

A method is described. The method may include the instructions are further executable by the processor to cause the apparatus to determine the first scheduled physical uplink shared channel partially overlaps the second scheduled physical uplink shared channel and puncturing the one or more resource elements associated with the data transmission on the second scheduled physical uplink shared channel is based on the first scheduled physical uplink shared channel partially overlapping the second scheduled physical uplink shared channel.

An apparatus is described. The apparatus may include a processor, memory coupled with the processor, and instructions stored in the memory. The instructions may be executable by the processor to cause the apparatus to the instructions be further executable by the processor to cause the apparatus to determine the first scheduled physical uplink shared channel partially overlaps the second scheduled physical uplink shared channel and puncture the one or more resource elements associated with the data transmission on the second scheduled physical uplink shared channel is based on the first scheduled physical uplink shared channel partially overlapping the second scheduled physical uplink shared channel.

Another apparatus is described. The apparatus may include means for the instructions are further executable by the processor to cause the apparatus to determine the first scheduled physical uplink shared channel partially overlaps the second scheduled physical uplink shared channel and means for puncturing the one or more resource elements associated with the data transmission on the second scheduled physical uplink shared channel is based on the first scheduled physical uplink shared channel partially overlapping the second scheduled physical uplink shared channel.

A non-transitory computer-readable medium storing code is described. The code may include instructions executable by a processor to the instructions be further executable by the processor to cause the apparatus to determine the first scheduled physical uplink shared channel partially overlaps the second scheduled physical uplink shared channel and puncture the one or more resource elements associated with the data transmission on the second scheduled physical uplink shared channel is based on the first scheduled physical uplink shared channel partially overlapping the second scheduled physical uplink shared channel.

A method is described. The method may include the instructions are further executable by the processor to cause the apparatus to receive UE capability information including an indication of a UE capability to puncture the one or more resource elements associated with the data transmission on the second scheduled physical uplink shared channel and transmitting the message is based on the received UE capability information.

An apparatus is described. The apparatus may include a processor, memory coupled with the processor, and instructions stored in the memory. The instructions may be executable by the processor to cause the apparatus to the instructions be further executable by the processor to cause the apparatus to receive UE capability information including an indication of a UE capability to puncture the one or more resource elements associated with the data transmission on the second scheduled physical uplink shared channel and transmit the message is based on the received UE capability information.

Another apparatus is described. The apparatus may include means for the instructions are further executable by the processor to cause the apparatus to receive UE capability information including an indication of a UE capability to puncture the one or more resource elements associated with the data transmission on the second scheduled physical uplink shared channel and means for transmitting the message is based on the received UE capability information.

A non-transitory computer-readable medium storing code is described. The code may include instructions executable by a processor to the instructions be further executable by the processor to cause the apparatus to receive UE capability information including an indication of a UE capability to puncture the one or more resource elements associated with the data transmission on the second scheduled physical uplink shared channel and transmit the message is based on the received UE capability information.

A method is described. The method may include the instructions to receive the indication are executable by the processor to cause the apparatus to receive a downlink control information message including the indication to rate match the one or more resources associated with the phase tracking reference signal transmission and rate matching the one or more resources associated with the phase tracking reference signal transmission is based on the received downlink control information message.

An apparatus is described. The apparatus may include a processor, memory coupled with the processor, and instructions stored in the memory. The instructions may be executable by the processor to cause the apparatus to the instructions to receive the indication are executable by the processor to cause the apparatus to receive a downlink control information message including the indication to rate match the one or more resources associated with the phase tracking reference signal transmission and rate match the one or more resources associated with the phase tracking reference signal transmission is based on the received downlink control information message.

Another apparatus is described. The apparatus may include means for the instructions to receive the indication are executable by the processor to cause the apparatus to receive a downlink control information message including the indication to rate match the one or more resources associated with the phase tracking reference signal transmission and means for rate matching the one or more resources associated with the phase tracking reference signal transmission is based on the received downlink control information message.

A non-transitory computer-readable medium storing code is described. The code may include instructions executable by a processor to the instructions to receive the indication are executable by the processor to cause the apparatus to receive a downlink control information message including the indication to rate match the one or more resources associated with the phase tracking reference signal transmission and rate match the one or more resources associated with the phase tracking reference signal transmission is based on the received downlink control information message.

In some examples of the method, apparatuses, and non-transitory computer-readable medium described herein, the instructions may be further executable by the processor to cause the apparatus to select at least one phase tracking reference signal transmission pattern of a set of phase tracking reference signal transmission patterns based on the indication in the received downlink control information message and rate matching the one or more resources associated with the phase tracking reference signal transmission may be based on the selected phase tracking reference signal transmission pattern of the set of phase tracking reference signal transmission patterns.

In some examples of the method, apparatuses, and non-transitory computer-readable medium described herein, the instructions may be further executable by the processor to cause the apparatus to determine one or more of a phase tracking reference signal transmission density, an offset of the one or more resources associated with the phase tracking reference signal transmission, or a location of the one or more resources associated with the phase tracking reference signal transmission, based on the selected phase tracking reference signal transmission pattern and rate matching the one or more resources associated with the phase tracking reference signal transmission may be based on one or more of the phase tracking reference signal transmission density, the offset of the one or more resources associated with the phase tracking reference signal transmission, or the location of the one or more resources associated with the phase tracking reference signal transmission.

In some examples of the method, apparatuses, and non-transitory computer-readable medium described herein, the instructions may be further executable by the processor to cause the apparatus to determine one or more antenna ports associated with the phase tracking reference signal transmission based on the indication in the received downlink control information message and rate matching the one or more resources associated with the phase tracking reference signal transmission may be based on the one or more antenna ports associated with the phase tracking reference signal transmission.

A method is described. The method may include the instructions are further executable by the processor to cause the apparatus to power boosting the phase tracking reference signal transmission on the scheduled physical uplink shared channel based on rate matching the one or more resources associated with the phase tracking reference signal transmission.

An apparatus is described. The apparatus may include a processor, memory coupled with the processor, and instructions stored in the memory. The instructions may be executable by the processor to cause the apparatus to the instructions be further executable by the processor to cause the apparatus to power boosting the phase tracking reference signal transmission on the scheduled physical uplink shared channel based on rate matching the one or more resources associated with the phase tracking reference signal transmission.

Another apparatus is described. The apparatus may include means for the instructions are further executable by the processor to cause the apparatus to power boosting the phase tracking reference signal transmission on the scheduled physical uplink shared channel based on rate matching the one or more resources associated with the phase tracking reference signal transmission.

A non-transitory computer-readable medium storing code is described. The code may include instructions executable by a processor to the instructions be further executable by the processor to cause the apparatus to power boosting the phase tracking reference signal transmission on the scheduled physical uplink shared channel based on rate matching the one or more resources associated with the phase tracking reference signal transmission.

In some examples of the method, apparatuses, and non-transitory computer-readable medium described herein, the instructions may be further executable by the processor to cause the apparatus to determine to refrain from a second phase tracking reference signal transmission on the scheduled physical uplink shared channel based on the indication and power boosting the phase tracking reference signal transmission on the scheduled physical uplink shared channel may be based on determining to refrain from the second phase tracking reference signal transmission on the scheduled physical uplink shared channel.

A method is described. The method may include the one or more resources include one or more of resource elements, resource blocks, symbols, or slots.

An apparatus is described. The apparatus may include a processor, memory coupled with the processor, and instructions stored in the memory. The instructions may be executable by the processor to cause the apparatus to the one or more resources include one or more of resource elements, resource blocks, symbols, or slots.

Another apparatus is described. The apparatus may include means for the one or more resources include one or more of resource elements, resource blocks, symbols, or slots.

A non-transitory computer-readable medium storing code is described. The code may include instructions executable by a processor to the one or more resources include one or more of resource elements, resource blocks, symbols, or slots.

A method is described. The method may include the one or more resources include one or more periodic resources.

An apparatus is described. The apparatus may include a processor, memory coupled with the processor, and instructions stored in the memory. The instructions may be executable by the processor to cause the apparatus to the one or more resources include one or more periodic resources.

Another apparatus is described. The apparatus may include means for the one or more resources include one or more periodic resources.

A non-transitory computer-readable medium storing code is described. The code may include instructions executable by a processor to the one or more resources include one or more periodic resources.

A method is described. The method may include the instructions to transmit the message are executable by the processor to cause the apparatus to transmit a downlink control information message including the indication to rate match the one or more resources associated with the phase tracking reference signal transmission.

An apparatus is described. The apparatus may include a processor, memory coupled with the processor, and instructions stored in the memory. The instructions may be executable by the processor to cause the apparatus to the instructions to transmit the message are executable by the processor to cause the apparatus to transmit a downlink control information message including the indication to rate match the one or more resources associated with the phase tracking reference signal transmission.

Another apparatus is described. The apparatus may include means for the instructions to transmit the message are executable by the processor to cause the apparatus to transmit a downlink control information message including the indication to rate match the one or more resources associated with the phase tracking reference signal transmission.

A non-transitory computer-readable medium storing code is described. The code may include instructions executable by a processor to the instructions to transmit the message are executable by the processor to cause the apparatus to transmit a downlink control information message including the indication to rate match the one or more resources associated with the phase tracking reference signal transmission.

In some examples of the method, apparatuses, and non-transitory computer-readable medium described herein, the transmitted downlink control information message includes a set of phase tracking reference signal transmission patterns.

In some examples of the method, apparatuses, and non-transitory computer-readable medium described herein, at least one phase tracking reference signal transmission pattern of a set of phase tracking reference signal transmission patterns includes one or more of a phase tracking reference signal transmission density, an offset of the one or more resources associated with the phase tracking reference signal transmission, or a location of the one or more resources associated with the phase tracking reference signal transmission.

A method is described. The method may include the indication includes a rate match indicator, a zero-power reference signal indicator, or a reference signal port indicator.

An apparatus is described. The apparatus may include a processor, memory coupled with the processor, and instructions stored in the memory. The instructions may be executable by the processor to cause the apparatus to the indication include a rate match indicator, a zero-power reference signal indicator, or a reference signal port indicator.

Another apparatus is described. The apparatus may include means for the indication includes a rate match indicator, a zero-power reference signal indicator, or a reference signal port indicator.

A non-transitory computer-readable medium storing code is described. The code may include instructions executable by a processor to the indication include a rate match indicator, a zero-power reference signal indicator, or a reference signal port indicator.

A method is described. The method may include the one or more resources include one or more of resource elements, resource blocks, symbols, or slots.

An apparatus is described. The apparatus may include a processor, memory coupled with the processor, and instructions stored in the memory. The instructions may be executable by the processor to cause the apparatus to the one or more resources include one or more of resource elements, resource blocks, symbols, or slots.

Another apparatus is described. The apparatus may include means for the one or more resources include one or more of resource elements, resource blocks, symbols, or slots.

A non-transitory computer-readable medium storing code is described. The code may include instructions executable by a processor to the one or more resources include one or more of resource elements, resource blocks, symbols, or slots.

### BRIEF DESCRIPTION OF THE DRAWINGS

FIGS. 1 and 2 illustrate examples of wireless communications systems that support phase-tracking reference signal (PTRS) alignment for a physical shared channel in accordance with aspects of the present disclosure.

FIGS. 3 and 4 illustrate examples of resource grids that support PTRS alignment for a physical shared channel in accordance with aspects of the present disclosure.

FIGS. 5 and 6 illustrate examples of process flows that support PTRS alignment for a physical shared channel in accordance with aspects of the present disclosure.

FIGS. 7 and 8 show block diagrams of devices that support PTRS alignment for a physical shared channel in accordance with aspects of the present disclosure.

FIG. 9 shows a block diagram of a communications manager that supports PTRS alignment for a physical shared channel in accordance with aspects of the present disclosure.

FIG. 10 shows a diagram of a system including a device that supports PTRS alignment for a physical shared channel in accordance with aspects of the present disclosure.

FIGS. 11 and 12 show block diagrams of devices that support PTRS alignment for a physical shared channel in accordance with aspects of the present disclosure.

FIG. 13 shows a block diagram of a communications manager that supports PTRS alignment for a physical shared channel in accordance with aspects of the present disclosure.

FIG. 14 shows a diagram of a system including a device that supports PTRS alignment for a physical shared channel in accordance with aspects of the present disclosure.

FIGS. 15-18 show flowcharts illustrating methods that support PTRS alignment for a physical shared channel in accordance with aspects of the present disclosure.

### DETAILED DESCRIPTION

Some wireless communication systems may include communication devices, such as user equipments (UEs) and base stations, for example, next-generation NodeBs or giga-NodeBs (either of which may be referred to as a gNB) that may support multiple radio access technologies including fifth generation (5G) systems, which may be referred to as New Radio (NR) systems, among others. Some wireless communication systems may experience relatively high levels of data traffic due to an increase in demand for a wide range of broadband applications and services by the communication devices. Some wireless communication systems may support millimeter wave radio frequency spectrum bands, which can offer larger bandwidth to the communication devices to boost data traffic capacity. Operating in the millimeter radio frequency spectrum bands, however, may result in a phase-noise factor (for example, a fluctuation in the phase of a waveform that adversely affects a signal), which may negatively impact performance for the communication devices.

Some wireless communication systems may support use of phase tracking reference signals (PTRS) to track and correct the phase-noise. Because of the relatively high levels of data traffic, however, the communication devices may be scheduled to transmit or receive data traffic on multiple data channels including physical downlink shared channels (PDSCH) and physical uplink shared channels (PUSCH). These data channels may be subject to a level of interference due to an overlap of resources between data channels, leading to missed data traffic transmission or reception. For example, resources used for PTRS on one data channel may overlap with resources used for data on another data channel.

Various aspects of the described techniques generally relate to configuring a communication device, such as a UE, to puncture resources of at least one data channel, and more specifically, to puncturing resources of a first data channel that has data multiplexed with resources of a second data channel for a PTRS transmission. A network communication device (for example, a base station) may configure the UE via a radio resource control (RRC) configuration message or a downlink control information (DCI) message to support the puncturing of resources of the first data channel that has the data multiplexed with resources of the second data channel for the PTRS transmission. The UE may also provide capability information to the network communication device, for example, to indicate whether the UE supports the puncturing. In some examples, puncturing the resources may be based on a PTRS density. For example, if a time density, or a frequency density, or both, associated with the PTRS is greater than (or equal to) or less than a threshold, the resources may be punctured or not punctured, respectively. Additionally or alternatively, to decrease interference between multiple data channels, the communication devices may be configured to rate match around resources for PTRS transmission on a data channel to avoid mapping data for a second data channel on overlapping resources.

Particular aspects of the subject matter described herein may be implemented to realize one or more of the following potential advantages. The techniques employed by the described wireless communications systems may provide benefits and enhancements to the operation of the wireless communications systems. For example, the described techniques may include features for decreasing or eliminating interference between multiple data channels, as well as improvements to power consumption, spectral efficiency, higher data rates, and high reliability, low latency communications, among other benefits.

Aspects of the disclosure are initially described in the context of wireless communications systems. Aspects of the disclosure are further illustrated by and described with reference to apparatus diagrams, system diagrams, and flowcharts that relate to PTRS alignment for a physical shared channel.

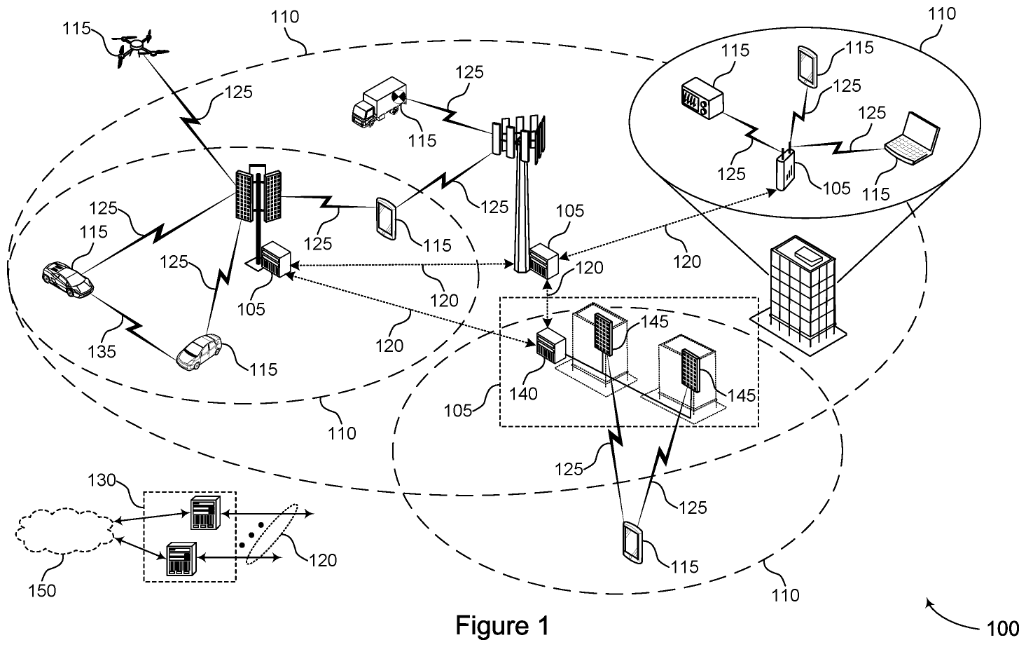

FIG. 1 illustrates an example of a wireless communications system 100 that supports PTRS alignment for a physical shared channel in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (for example, mission critical) communications, low latency communications, communications with low-cost and low-complexity devices. The wireless communications system 100 may support improvements to power consumption, spectral efficiency, higher data rates and, in some examples, may promote high reliability and low latency PTRS operations, among other benefits.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (for example, core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (for example, via an S1, N2, N3, or other interface). The base stations 105 may communicate with one another over the backhaul links 120 (for example, via an X2, Xn, or other interface) either directly (for example, directly between base stations 105), or indirectly (for example, via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, in which the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (for example, in a carrier aggregation configuration), a carrier may also have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode in which initial acquisition and connection may be conducted by the UEs 115 via the carrier, or the carrier may be operated in a non-standalone mode in which a connection is anchored using a different carrier (for example, of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (for example, in an FDD mode) or may be configured to carry downlink and uplink communications (for example, in a TDD mode). A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol duration (for example, a duration of one modulation symbol) and one subcarrier, in which the symbol duration and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, in which a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the base stations 105 or the UEs 115 may be expressed in multiples of a basic time unit which may, for example, refer to a sampling duration of Tₛ=1/(Δfₘₐₓ·N_{f}) seconds, in which Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol durations (for example, depending on the length of the cyclic prefix prepended to each symbol duration). In some wireless communications systems 100, a slot may further be divided into multiple mini-slots containing one or more symbols. Excluding the cyclic prefix, each symbol duration may contain one or more (for example, N_{f}) sampling durations. The duration of a symbol duration may depend on the subcarrier spacing or frequency band of operation. A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol durations in a TTI) may be variable. Additionally or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol durations and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

A UE 115 may determine that one or more resource elements associated with a phase tracking reference signal transmission on a first scheduled PUSCH are multiplexed with one or more resource elements associated with a data transmission on a second scheduled PUSCH. The UE 115 may puncture the one or more resource elements associated with the data transmission on the second scheduled PUSCH based the determining, and transmit the PTRS transmission on the first scheduled PUSCH based on puncturing the one or more resource elements associated with the data transmission on the second scheduled PUSCH. Alternatively, the UE 115 may determine one or more resources associated with a PTRS transmission on a scheduled PUSCH. The UE 115 may receive an indication to rate match the one or more resources associated with the PTRS transmission, and rate match the one or more resources associated with the PTRS transmission around one or more additional resources based on the indication. The UE 115 may, as a result, transmit the PTRS transmission on the scheduled PUSCH based on the rate matching.

Each base station 105 may provide communication coverage via one or more cells, for example a macro cell, a small cell, a hot spot, or other types of cells. The term “cell” may refer to a logical communication entity used for communication with a base station 105 (for example, over a carrier) and may be associated with an identifier for distinguishing neighboring cells (for example, a physical cell identifier (PCID), a virtual cell identifier (VCID), or others). In some examples, a cell may also refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (for example, MTC, narrowband IoT (NB-IoT), enhanced mobile broadband (eMBB)) that may provide access for different types of devices.

In some examples, a base station 105 may be movable and provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode if not engaging in active communications, operating over a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other examples, D2D communications are carried out between the UEs 115 without the involvement of a base station 105.

In some systems, the D2D communication link 135 may be an example of a communication channel, such as a sidelink communication channel, between vehicles (for example, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (for example, from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. If operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), in which multiple spatial layers are transmitted to the same receiving device, and multiple-user MIMO (MU-MIMO), in which multiple spatial layers are transmitted to multiple devices.

Beamforming, which may also be referred to as spatial filtering, directional transmission, or directional reception, is a signal processing technique that may be used at a transmitting device or a receiving device (for example, a base station 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example, by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (for example, by a base station 105 or a UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) if receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, if receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which the device may provide HARQ feedback in a specific slot for data received in a previous symbol in the slot. In other examples, the device may provide HARQ feedback in a subsequent slot, or according to some other time interval.

The UEs 115 may support use of PTRS to track and correct a phase-noise factor. However, because of high levels of data traffic, the UEs 115 may be scheduled to transmit or receive data traffic on multiple data channels including PDSCH and PUSCH. These data channels may be subject to a level of interference due to an overlap between data channels, leading to missed data traffic transmission or reception. For example, resources associated with a PTRS transmission on one data channel may overlap with resources associated with data for a different data channel, causing data transmission to interfere with the PTRS transmission. To decrease or eliminate the interference between the multiple data channels and improve reliability of data traffic transmission including PTRS transmissions, various aspects of the described techniques relate to configuring the UEs 115 to puncture resources of at least one data channel that has data multiplexed with resources of another data channel for a PTRS transmission.

The base stations 105 may configure the UEs 115 via an RRC configuration message or a DCI message to support the puncturing of resources of the at least one data channel that has the data multiplexed with resources of another data channel for PTRS transmission. The UEs 115 may, in some examples, provide capability information to the base stations 105 to indicate whether the UEs 115 support the puncturing. In some examples, puncturing the resources may be based on a PTRS density. For example, if a time density or a frequency density, or both, associated with a PTRS transmission is greater than or less than a threshold, the resources may be punctured or not punctured accordingly. Additionally or alternatively, to decrease or eliminate interference between multiple data channels, the UEs 115 may be configured to rate match around PTRS resources on a data channel to avoid mapping data to overlapping resources associated with a different channel. In some examples, the PTRS resources may be power boosted based on the rate matched resources.

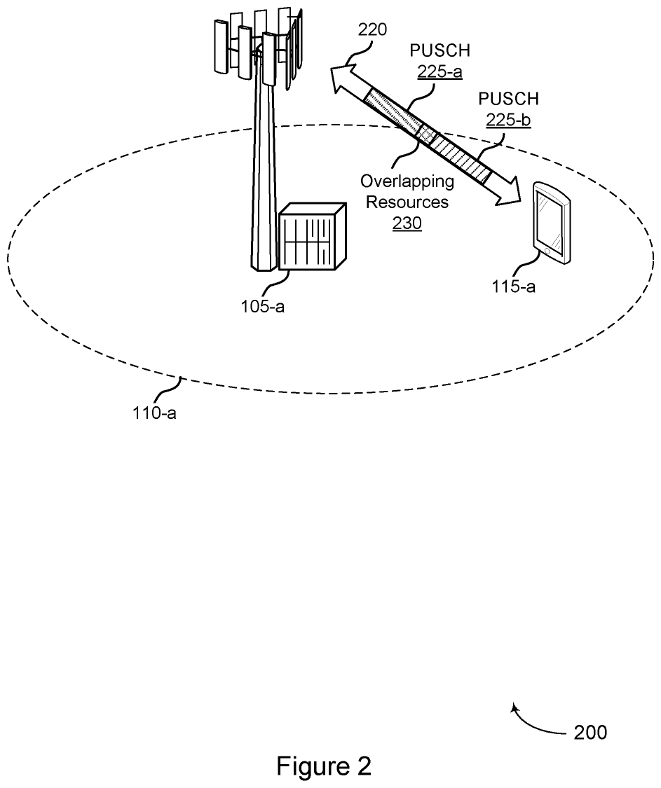

FIG. 2 illustrates an example of a wireless communications system 200 that supports PTRS alignment for a physical shared channel in accordance with aspects of the present disclosure. The wireless communications system 200 may implement aspects of the wireless communications system 100. For example, the wireless communications system 200 may include a base station 105-a and a UE 115-a within a geographic coverage area 110-a. The base station 105-a and the UE 115-a may be examples of a base station 105 and a UE 115 as described with reference to FIG. 1. In some examples, the wireless communications system 200 may support multiple radio access technologies including 4G systems such as LTE systems, LTE-A systems, or LTE-A Pro systems, and 5G systems which may be referred to as NR systems. The wireless communications system 200 may support improvements to power consumption, spectral efficiency, higher data rates and, in some examples, may promote high reliability and low latency PTRS transmissions, among other benefits.

The base station 105-a and the UE 115-a may be configured with multiple antennas, which may be used to employ techniques such as transmit diversity, receive diversity, multiple-input multiple-output communications, or beamforming. The antennas of the base station 105-a and the UE 115-a may be located within one or more antenna arrays or antenna panels, which may support multiple-input multiple-output operations or transmit or receive beamforming. For example, the base station 105-a antennas or antenna arrays may be co-located at an antenna assembly, such as an antenna tower. In some examples, antennas or antenna arrays associated with the base station 105-a may be located in diverse geographic locations. The base station 105-a may have an antenna array with a number of rows and columns of antenna ports that the base station 105-a may use to support beamforming of communications with the UE 115-a. Likewise, the UE 115-a may have one or more antenna arrays that may support various multiple-input multiple-output or beamforming operations. Additionally or alternatively, an antenna panel may support radio frequency beamforming for a signal transmitted via one or more antenna ports.

The base station 105-a and the UE 115-a may thus be configured to support directional communications 205 (for example, beamformed communications) using the multiple antennas. The base station 105-a and the UE 115-a may communicate via the directional communications 205 using multiple component carriers. For example, the base station 105-a and the UE 115-a may be configured to support multiple downlink component carriers and multiple uplink component carriers. The base station 105-a and the UE 115-a may be configured to support the directional communications 205 over a carrier bandwidth or may be configured to support the directional communications 205 over one of multiple carrier bandwidths.

In some cases, the UE 115-a may experience a phase-noise factor, which may impact performance for the UE 115-a. The UE 115-a, in the wireless communications system 200, may support operations to preserve resources (for example, time and frequency resources of the wireless communications system 200) or a battery life of the UE 115-a, among other examples. In some examples, the UE 115-b may be configured to support operations to manage or improve the directional communications 205 between the base station 105-a and the UE 115-a. For example, the base station 105 may configure the UE 115 to support PTRS alignment over data channels (for example, PUSCH), so that the UE 115-a may track a phase-noise factor in the wireless communications system 200 and decrease or eliminate the phase-noise factor.

The base station 105-a may allocate time and frequency resources for one or multiple data channels including downlink data channels (for example, PDSCH) and uplink data channels (for example, PUSCH). In the example of FIG. 2, the base station 105-a may schedule a first PUSCH 225-a and a second PUSCH 225-b. The UE 115-a may determine one or more overlapping resources 230 associated with the PUSCH 225-a and the PUSCH 225-b. For example, the UE 115-a may determine that one or more resource elements of a PTRS transmission on the scheduled PUSCH 225-a overlap with one or more resource elements of a data transmission on the scheduled PUSCH 225-b. In other words, the PTRS transmission on the scheduled PUSCH 225-a may be multiplexed with the data transmission on the scheduled PUSCH 225-b.

In some cases, the overlap between the one or more resource elements of the PTRS transmission on the scheduled PUSCH 225-a and the one or more resource elements of the data transmission on the scheduled PUSCH 225-b may cause interference for the PTRS transmission. To decrease or eliminate the interference and improve reliability of the PTRS transmission, the UE 115-a may be configured to puncture the one or more resource elements of the scheduled PUSCH 225-b associated with the data transmission. In some examples, the base station 105-a may transmit an indication, for example, in an RRC configuration message or a DCI message indicating to the UE 115-a to puncture the one or more overlapping resources 230 associated with the PUSCH 225-b.

The UE 115-a may puncture the overlapping resources 230, for example, based on receiving the indication from the base station 105-a. Based on the puncturing of the overlapping resources 230, the UE 115-a may transmit the PTRS transmission on the scheduled PUSCH 225-a without interference from the scheduled PUSCH 225-b because no data transmission on the scheduled PUSCH 225-a occurs on the punctured resource elements associated with the scheduled PUSCH 225-b.

Alternatively, the UE 115-a may be configured to rate match the one or more resource elements of the PTRS transmission on the scheduled PUSCH 225-a around one or more other resources. These other resources may be associated with the scheduled PUSCH 225-b. In some examples, rate-matching may include selectively repeating or puncturing resources to match a number of resources used for data to a number of resources being transmitted. In some examples, rate matching the PTRS transmission on the scheduled PUSCH 225-a may enable the UE 115-a to avoid mapping data associated with the scheduled PUSCH 225-b on the one or more resources of the PTRS transmission. Avoiding mapping data on the one or more resources of the PTRS transmission may decrease or eliminate interference between data channels. In some examples, the UE 115-a may power-boost PTRS transmission based on rate matching the resources. For example, the UE 115-a may determine that one or more resources are not being used for data transmission because of the rate matching used for the PTRS resources and may dedicate transmit power associated with the unused resources to the PTRS resources.

By implementing various aspects of the disclosure, the wireless communications system 200 may, as a result, include features for improvements to PTRS operations for data channels and, in some examples, may promote high reliability and low latency PTRS transmissions. The wireless communications system 200 may also include features for reducing a phase-noise factor by improving transmission of PTRS transmissions for data channels.

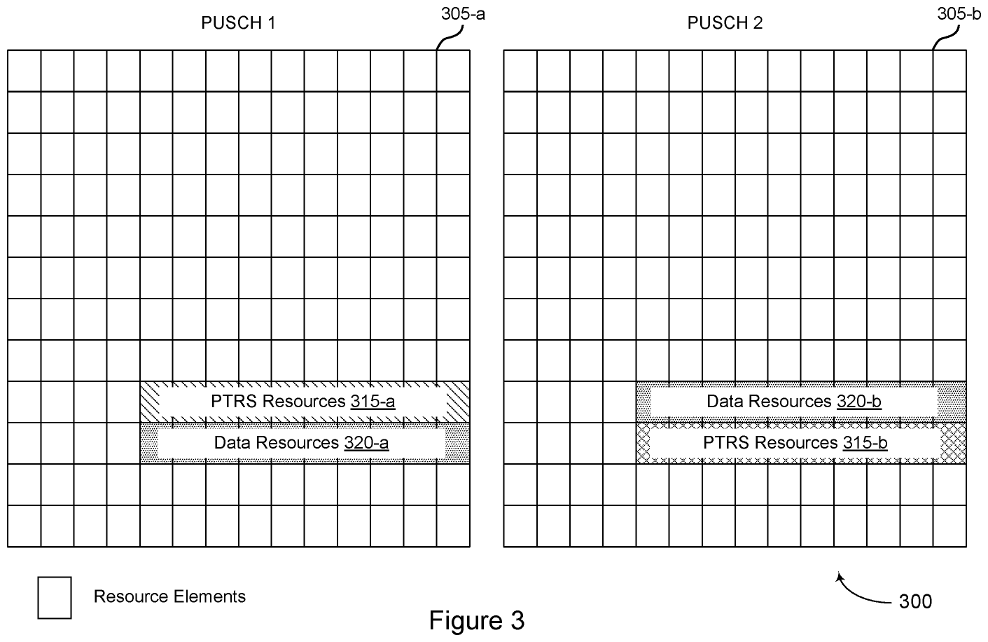

FIG. 3 illustrates an example of a set of resource grids 300 that support PTRS alignment for a physical shared channel in accordance with aspects of the present disclosure. The set of resource grids 300 may implement aspects of the wireless communications system 100 and 200 described with reference to FIGS. 1 and 2, respectively. For example, the set of resource grids 300 may be based on a configuration by a base station 105 and implemented by a UE 115. The set of resource grids 300 may be used to achieve greater reliability and lower latency PTRS operations in a wireless communications system. The set of resource grids 300 may also be based on a configuration by the base station 105, and implemented by the UE 115 to decrease power consumption by the UE 115 if performing phase-tracking operations (for example, PTRS transmissions), among other benefits.

In the example illustrated in FIG. 3, the set of resource grids 300 include a first resource grid 305-a and a second resource grid 305-b, which include time resources (for example, symbols, minislots, slots, subframes, or a frame) as well as frequency resources (for example, carriers or subcarriers). A combination of a time resource, such as a symbol, and a frequency resource, such as a subcarrier, may define an associated resource element. In the example illustrated in FIG. 3, the base station 105 schedules the UE 115 with multiple PUSCH. For example, the first resource grid 305-a may be associated with a first scheduled PUSCH, while the second resource grid 305-b may be associated with a second scheduled PUSCH. In some examples, the UE 115 may transmit a PTRS transmission on the first scheduled PUSCH using one or more PTRS resources 315-a associated with the first resource grid 305-a. Similarly, the UE 115 may transmit a PTRS transmission of the second scheduled PUSCH using one or more PTRS resources 315-b associated with the second resource grid 305-b.

One or more resources (for example, resource elements) associated with the first resource grid 305-a may overlap with one or more resources (for example, resource elements) associated with the second resource grid 305-b. For example, the one or more PTRS resources 315-a associated with the first resource grid 305-a may overlap with one or more data resources 320-b associated with the second resource grid 305-b. Thus, the one or more PTRS resources 315-a associated with a PTRS transmission on the first scheduled PUSCH may be multiplexed with the one or more data resources 320-b associated with a data transmission on the second scheduled PUSCH. The UE 115 may puncture the one or more data resources 320-b associated with the data transmission on the second scheduled PUSCH, to improve the PTRS transmission on the first scheduled PUSCH over the one or more PTRS resources 315-a.

As also shown in the example of FIG. 3, one or more PTRS resources 315-b associated with the second resource grid 305-b may overlap with one or more data resources 320-a associated with the first resource grid 305-a. That is, the one or more PTRS resources 315-b associated with a PTRS transmission on the second scheduled PUSCH may be multiplexed with the one or more data resources 320-a associated with a data transmission on the first scheduled PUSCH. As similarly described above, the UE 115 may puncture the one or more data resources 320-a associated with the data transmission on the first scheduled PUSCH, to improve the PTRS transmission on the second scheduled PUSCH over the one or more PTRS resources 315-b.

The UE 115 may determine to puncture one or more resources associated with the set of resource grids 300 based on signaling from the base station 105. For example, the UE 115 may receive an indication in an RRC configuration message or a DCI message indicating to the UE 115 to puncture one or more resource elements associated with a data transmission on a second scheduled PUSCH based on one or more resource elements associated with a PTRS transmission on a first scheduled PUSCH being multiplexed with the one or more resource elements associated with the data transmission on the second scheduled PUSCH. The puncturing of the resource elements enables interference mitigation for the UE 115, if one or more resource elements associated with a PTRS transmission on a first scheduled PUSCH are multiplexed (for example, overlapping) with one or more resource elements associated with the data transmission on the second scheduled PUSCH. Based on implementing the puncturing, the UE 115 may also reduce its power consumption and facilitate high reliability and low latency PTRS transmissions, among other benefits.

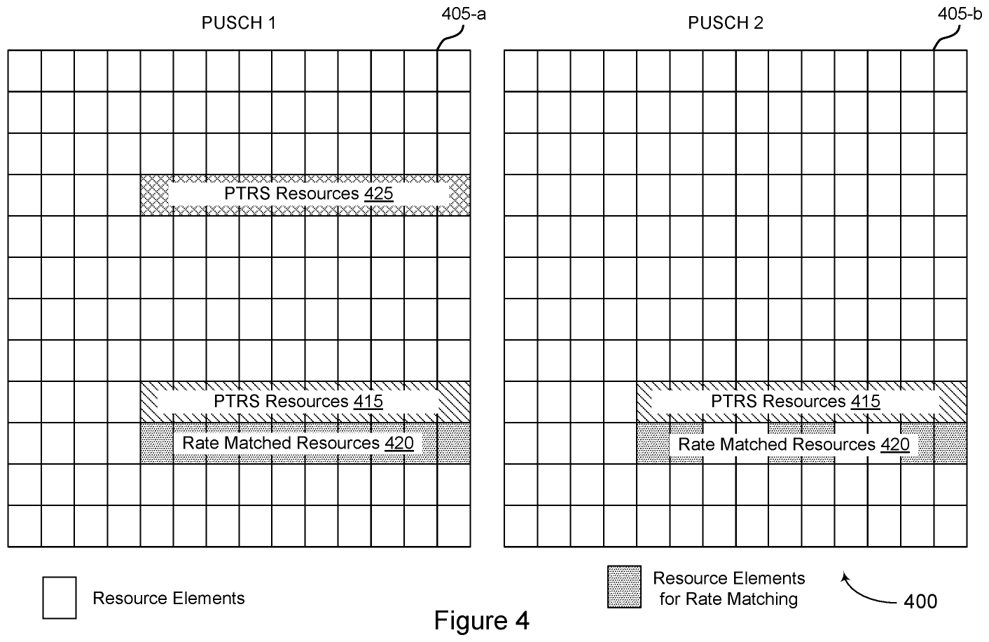

FIG. 4 illustrates an example of a set of resource grids 400 that support PTRS alignment for a physical shared channel in accordance with aspects of the present disclosure. The set of resource grids 400 may implement aspects of the wireless communications system 100 and 200 described with reference to FIGS. 1 and 2, respectively. For example, the set of resource grids 400 may be based on a configuration by a base station 105 and implemented by a UE 115. The set of resource grids 400 may be used to achieve higher reliability and lower latency PTRS operations in a wireless communications system. The set of resource grids 400 may also be based on a configuration by the base station 105, and implemented by the UE 115 to decrease power consumption by the UE 115 if performing phase-tracking operations, among other benefits.

In the example illustrated in FIG. 4, the set of resource grids 400 includes a first resource grid 405-a and a second resource grid 405-b, which include time resources (for example, symbols, minislots, slots, subframes, or a frame) as well as frequency resources (for example, carriers or subcarriers). A combination of a time resource, such as a symbol, and a frequency resource, such as a subcarrier, may define an associated resource element. In the example illustrated in FIG. 3, the base station 105 schedules the UE 115 with multiple PUSCH. For example, the first resource grid 405-a may be associated with a first scheduled PUSCH, while the second resource grid 405-b may be associated with a second scheduled PUSCH. In some examples, the UE 115 may transmit a PTRS transmission on the first scheduled PUSCH using one or more PTRS resources 415 associated with the first resource grid 405-a. Similarly, the UE 115 may transmit a PTRS transmission of the second scheduled PUSCH using one or more PTRS resources 415 associated with the second resource grid 405-b.

The UE 115 may be configured to rate match one or more resources associated with the set of resource grids 400 to yield one or more rate-matched resources. For example, the UE 115 may rate match one or more resources 420 of the first scheduled PUSCH or of the second scheduled PUSCH, or both. In some examples, the UE 115 may receive an indication (for example, an RRC configuration message, a DCI message) from the base station 105 indicating a number of resource elements (for example, the one or more resources 420) to rate match around. In some examples, the UE 115 may perform a power boosting operation on the PTRS resources 415 based on the rate-matched resources. In some implementations the PTRS resources 415 may be power-boosted if there is not a second set of resources associated with a second PTRS transmission. In some examples, the PTRS resources 415 may be a first set of PTRS resources where the UE 115 is configured to transmit a PTRS on a first set of PTRS resources 415 and a second set of PTRS resources 425. In some examples, the UE 115 may transmit the first PTRS transmission for a scheduled PUSCH and may be indicated to not transmit on the second set of PTRS resources 420. In such examples, power boosting can be applied to the first set of PTRS resources 415 for PTRS transmission. Based on implementing the rate matching, the UE 115 may experience high reliability and low latency PTRS transmissions, among other benefits.

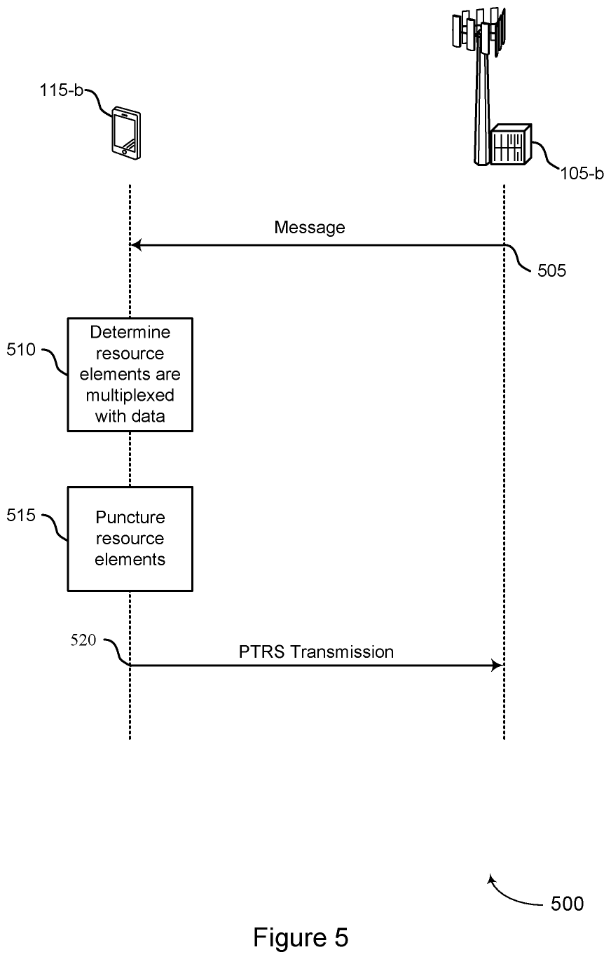

FIG. 5 illustrates an example of a process flow 500 that supports PTRS alignment for a physical shared channel in accordance with aspects of the present disclosure. The process flow 500 may implement aspects of the wireless communications system 100 and 200 described with reference to FIGS. 1-4, respectively. The process flow 500 may be based on a configuration by a base station 105-b or a UE 115-b, and implemented by the UE 115-b. The process flow 500 may achieve higher reliability and lower latency reference signaling operations (for example, PTRS transmission) in a wireless communications system. The process flow 500 may also be based on a configuration by the base station 105-b or the UE 115-b and implemented by the UE 115-b to decrease power consumption by the UE 115-b if performing phase-tracking operations (for example, PTRS transmission), among other benefits. The base station 105-b and the UE 115-b may be examples of a base station 105 and a UE 115, as described with reference to FIGS. 1 and 2. In some examples other operations may be added to the process flow 500.

At 505, the base station 105-b may transmit a message including an indication to puncture one or more resource elements associated with a data transmission on a second scheduled PUSCH based on one or more resource elements associated with a PTRS transmission on a first scheduled PUSCH being multiplexed with the one or more resource elements associated with the data transmission on the second scheduled PUSCH. For example, the base station 105-b may schedule multiple PUSCH including the first PUSCH and the second PUSCH, and, based on the multiple scheduled PUSCH, may transmit the message indicating to the UE 115-b to puncture the one or more resource elements associated with the data transmission on the second scheduled PUSCH. In some examples, the base station 105-b may transmit an RRC configuration message including the indication to puncture the one or more resource elements associated with the data transmission on the second scheduled PUSCH. In some other examples, the base station 105-b may transmit a DCI message including the indication to puncture the one or more resource elements associated with the data transmission on the second scheduled PUSCH. The base station 105-b may, in some examples, receive UE capability information from the UE 115-b prior to transmitting the indication. The UE capability information may include an indication that the UE 115-b is capable of puncturing the one or more resource elements associated with the data transmission on the second scheduled PUSCH.

At 510, the UE 115-b may determine that one or more resource elements associated with the PTRS transmission on the first scheduled PUSCH are multiplexed with one or more resource elements associated with the data transmission on the second scheduled PUSCH. For example, the UE 115-b may determine that the one or more resource elements associated with the PTRS transmission on the first scheduled PUSCH are multiplexed with the one or more resource elements associated with the data transmission on the second scheduled PUSCH based on receiving the message (for example, the RRC configuration message or the DCI message) from the base station 105-b. At 515, the UE 115-b may puncture the one or more resource elements associated with the data transmission on the second scheduled PUSCH. At 520, the UE 115-b may transmit a PTRS transmission, for example, on the first scheduled PUSCH, based on puncturing the one or more resource elements associated with the data transmission on the second scheduled PUSCH.

In some examples, the UE 115-b may determine a PTRS density associated with the first scheduled PUSCH, for example, in a time domain or a frequency domain, or both. In some examples, a PTRS may have a time density L_{PTRS} of four, two, or one symbols. In some examples, a PTRS may have a frequency density K_{PTRS} of four or two resource blocks. The UE 115-b may determine that the PTRS density associated with the first scheduled PUSCH is greater than a PTRS density threshold. Based on the determination that the PTRS density associated with the first scheduled PUSCH is greater than the PTRS density threshold, the UE 115-b may puncture the one or more resource elements associated with the data transmission on the second scheduled PUSCH. Alternatively, the UE 115-b may refrain from puncturing the one or more resource elements associated with the data transmission on the second scheduled PUSCH, if the PTRS density associated with the first scheduled PUSCH is greater than the PTRS density threshold.

In some other examples, the UE 115-b may determine that the PTRS density associated with the first scheduled PUSCH is less than the PTRS density threshold. Based on the determination that the PTRS density associated with the first scheduled PUSCH is less than the PTRS density threshold, the UE 115-b may puncture the one or more resource elements associated with the data transmission on the second scheduled PUSCH. Alternatively, the UE 115-b may refrain from puncturing the one or more resource elements associated with the data transmission on the second scheduled PUSCH, if the PTRS density associated with the first scheduled PUSCH is less than the PTRS density threshold. In some examples, the determination of whether to puncture based on the PTRS density threshold may be further based on a determination of interference resulting from the PTRS density and a number of overlapping resources.

The process flow 500 may thus enable the UE 115-b to puncture one or more resource elements associated with a data transmission on a second scheduled PUSCH. The puncturing of the resource elements may enable interference mitigation for the UE 115-b, if one or more resource elements associated with a PTRS transmission on a first scheduled PUSCH are multiplexed or overlapping with one or more resource elements associated with the data transmission on the second scheduled PUSCH. Based on implementing the puncturing as described herein in the process flow 500, one or more processors of the UE 115-b (for example, processor(s) controlling or incorporated with a UE communications manager as described herein) may achieve reduced power consumption and may achieve higher reliability and lower latency for wireless communications (for example, reference signal transmissions), among other benefits.

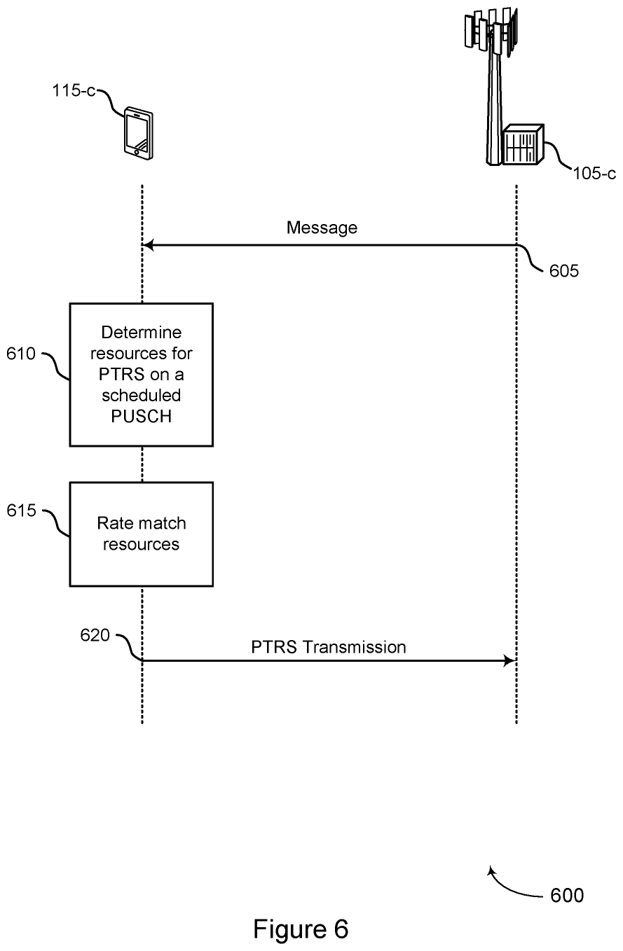

FIG. 6 illustrates an example of a process flow 600 that supports PTRS alignment for a physical shared channel in accordance with aspects of the present disclosure. The process flow 600 may implement aspects of the wireless communications system 100 and 200 described with reference to FIGS. 1-4, respectively. The process flow 600 may be based on a configuration by a base station 105-c, and implemented by a UE 115-c. The process flow 600 may enable higher reliability and lower latency for reference PTRS transmissions in a wireless communications system. The process flow 600 may also be based on a configuration by the base station 105-c or the UE 115-c and implemented by the UE 115-c to reduce power consumption by the UE 115-c if performing phase-tracking operations (for example, PTRS transmission), among other benefits. The base station 105-c and the UE 115-c may be examples of a base station 105 and a UE 115, as described with reference to FIGS. 1 and 2. In some examples, other operations may be added to the process flow 600.

At 605, the base station 105-c may transmit a message including an indication to rate match one or more resources associated with a PTRS transmission on a scheduled PUSCH around one or more other resources. Each of the one or more resources and the one or more other resources may include a resource element, a resource block, or other resource defined by a set of symbols or slots. In some examples, the base station 105-c may transmit an RRC configuration message including the indication to rate match the one or more resources associated with the PTRS transmission on the scheduled PUSCH around the one or more other resources. For example, the indication may be referred to as a rate match indicator. In some other examples, the base station 105-c may transmit a DCI message including the indication to rate match the one or more resources associated with the PTRS transmission on the scheduled PUSCH around the one or more other resources. In such examples, the indication may be a zero-power reference signal indicator.

At 610, the UE 115-c may determine the one or more resources associated with the PTRS transmission on the scheduled PUSCH. At 615, the UE 115-c may rate match the one or more resources associated with the PTRS transmission on the scheduled PUSCH around the one or more other resources. For example, the UE 115-c may determine the one or more resources associated with the PTRS transmission on the scheduled PUSCH and rate match the one or more resources associated with the PTRS transmission around the one or more other resources based on receiving the message (for example, the RRC configuration message or the DCI message) from the base station 105-c.

The UE 115-c may determine a set of PTRS transmission patterns based on receiving the message (for example, the RRC configuration message or the DCI message) from the base station 105-c. The UE 115-c may rate match the one or more resources associated with the PTRS transmission around the one or more other resources based on at least one PTRS transmission pattern of the set of PTRS transmission patterns. In some examples, the UE 115-c may determine a PTRS transmission density, an offset of the one or more resources associated with the PTRS transmission, or a location of the one or more resources associated with the PTRS transmission in a resource grid (for example, a resource block). The UE 115-c may rate match the one or more resources associated with the PTRS transmission around the one or more other resources based on the PTRS transmission density, the offset of the one or more resources associated with the PTRS transmission, or the location of the one or more resources associated with the PTRS transmission in the resource grid (for example, a resource block).

The UE 115-c may, in some examples, determine one or more antenna ports associated with the PTRS transmission based at least in part on the indication in the received message (for example, the RRC configuration message or the DCI message) from the base station 105-c. The indication may be a reference signal port indicator. The UE 115-c may rate match the one or more resources associated with the PTRS transmission around the one or more other resources based on the one or more antenna ports. At 620, the UE 115-c may transmit a PTRS transmission, for example, on the scheduled PUSCH based on rate matching around the one or more other resources. In some examples, the UE 115-c may power boost the PTRS transmission on the scheduled PUSCH based on rate matching the one or more resources associated with the PTRS transmission.

The process flow 600 may therefore enable the UE 115-c to rate match one or more resources associated with a PTRS transmission around one or more additional resources. The rate matched resources may enable interference mitigation for the UE 115-c, if one or more resource elements associated with a PTRS transmission on a first scheduled PUSCH are multiplexed or overlapping with one or more resource elements associated with the data transmission on the second scheduled PUSCH. Based on implementing the rate matching as described herein in the process flow 600, one or more processors of the UE 115-c (for example, processor(s) controlling or incorporated with a UE communications manager as described herein) may achieve a reduction in power consumption and may achieve higher reliability and lower latency for wireless communications (for example, reference signal transmissions), among other benefits.

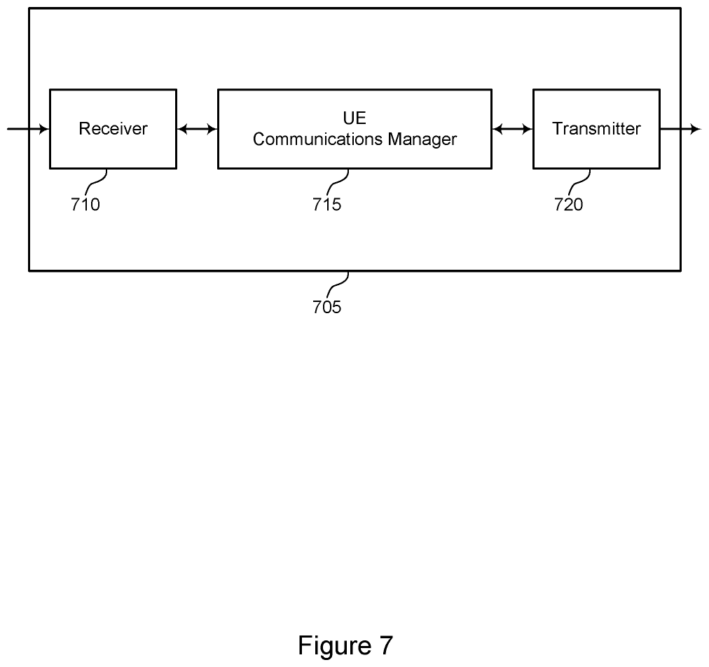

FIG. 7 shows a block diagram of a device 705 that supports PTRS alignment for a physical shared channel in accordance with aspects of the present disclosure. The device 705 may be an example of aspects of a UE 115 as described herein. The device 705 may include a receiver 710, a UE communications manager 715, and a transmitter 720. The UE communications manager 715 can be implemented, at least in part, by one or both of a modem and a processor. Each of these components may be in communication with one another (for example, via one or more buses).

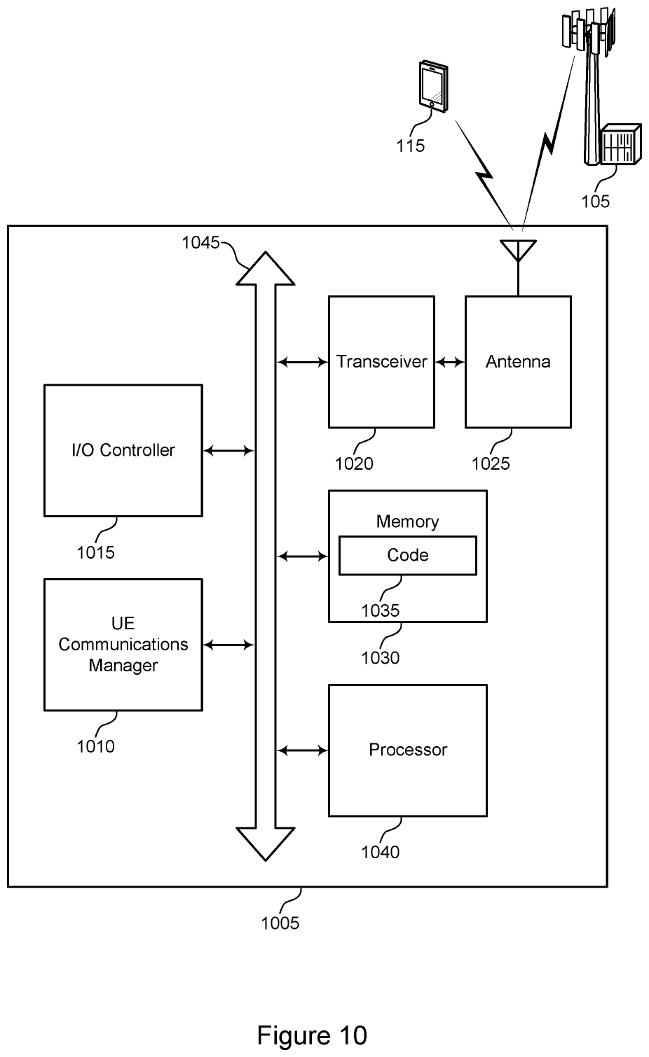

The receiver 710 may receive information such as packets, user data, or control information associated with various information channels (for example, control channels, data channels, and information related to PTRS alignment for a physical shared channel). Information may be passed on to other components of the device 705. The receiver 710 may be an example of aspects of the transceiver 1020 described with reference to FIG. 10. The receiver 710 may utilize a single antenna or a set of antennas.

The UE communications manager 715 may determine that one or more resource elements associated with a PTRS transmission on a first scheduled PUSCH are multiplexed with one or more resource elements associated with a data transmission on a second scheduled PUSCH. The UE communications manager 715 may puncture the one or more resource elements associated with the data transmission on the second scheduled PUSCH based on the determining, and transmit the PTRS transmission on the first scheduled PUSCH based on puncturing the one or more resource elements associated with the data transmission on the second scheduled PUSCH.

The UE communications manager 715 may be implemented as an integrated circuit or chipset for a mobile device modem, and the receiver 710 and the transmitter 720 may be implemented as analog components (for example, amplifiers, filters, antennas) coupled with the mobile device modem to enable wireless transmission and reception. The UE communications manager 715 as described herein may be implemented to realize one or more potential improvements. At least one implementation may enable the UE communications manager 715 to puncture one or more resource elements associated with a data transmission on a second scheduled PUSCH. Based on implementing the puncturing as described herein, one or more processors of the device 705 (for example, processor(s) controlling or incorporated with the UE communications manager 715) may experience reduce power consumption and promote high reliability and low latency wireless communications, among other benefits.

The UE communications manager 715 may also determine one or more resources associated with a PTRS transmission on a scheduled PUSCH. UE communications manager 715 may also receive an indication to rate match the one or more resources associated with the PTRS transmission and rate match the one or more resources associated with the PTRS transmission around one or more additional resources based on the indication. The UE communications manager 715 may transmit the PTRS transmission on the scheduled PUSCH based on the rate matching.

The UE communications manager 715 may be implemented as an integrated circuit or chipset for a mobile device modem, and the receiver 710 and the transmitter 720 may be implemented as analog components (for example, amplifiers, filters, antennas) coupled with the mobile device modem to enable wireless transmission and reception. The UE communications manager 715 as described herein may be implemented to realize one or more potential improvements. At least one implementation may enable the UE communications manager 715 to rate match one or more resources associated with a PTRS transmission around one or more additional resources. Based on implementing the rate matching as described herein, one or more processors of the device 705 (for example, processor(s) controlling or incorporated with the UE communications manager 715) may experience reduce power consumption and promote high reliability and low latency wireless communications, among other benefits.

The transmitter 720 may transmit signals generated by other components of the device 705. In some examples, the transmitter 720 may be collocated with a receiver 710 in a transceiver component. For example, the transmitter 720 may be an example of aspects of the transceiver 1020 described with reference to FIG. 10. The transmitter 720 may utilize a single antenna or a set of antennas.

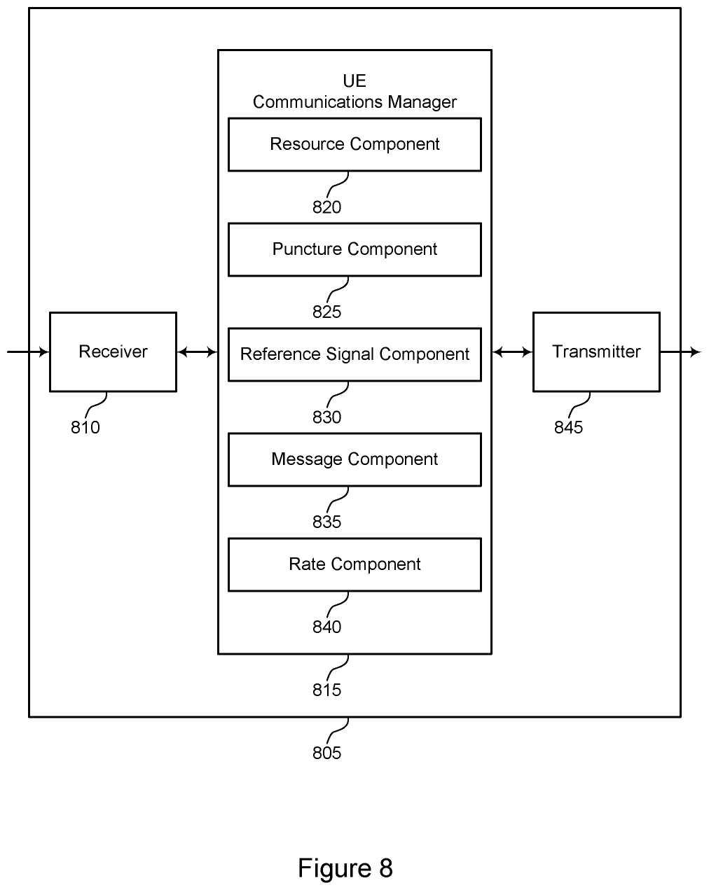

FIG. 8 shows a block diagram of a device 805 that supports PTRS alignment for a physical shared channel in accordance with aspects of the present disclosure. The device 805 may be an example of aspects of a device 705, or a UE 115 as described herein. The device 805 may include a receiver 810, a UE communications manager 815, and a transmitter 845. The UE communications manager 815 can be implemented, at least in part, by one or both of a modem and a processor. Each of these components may be in communication with one another (for example, via one or more buses).

The receiver 810 may receive information such as packets, user data, or control information associated with various information channels (for example, control channels, data channels, and information related to PTRS alignment for a physical shared channel). Information may be passed on to other components of the device 805. The receiver 810 may be an example of aspects of the transceiver 1020 described with reference to FIG. 10. The receiver 810 may utilize a single antenna or a set of antennas.

The UE communications manager 815 may include a resource component 820, a puncture component 825, a reference signal component 830, a message component 835, and a rate component 840. The resource component 820 may determine that one or more resource elements associated with a PTRS transmission on a first scheduled PUSCH are multiplexed with one or more resource elements associated with a data transmission on a second scheduled PUSCH. The puncture component 825 may puncture the one or more resource elements associated with the data transmission on the second scheduled PUSCH based on the determining. The reference signal component 830 may transmit the PTRS transmission on the first scheduled PUSCH based on puncturing the one or more resource elements associated with the data transmission on the second scheduled PUSCH. The resource component 820 may determine one or more resources associated with a PTRS transmission on a scheduled PUSCH. The message component 835 may receive an indication to rate match the one or more resources associated with the PTRS transmission. The rate component 840 may rate matching the one or more resources associated with the PTRS transmission around one or more additional resources based on the indication. The reference signal component 830 may transmit the PTRS transmission on the scheduled PUSCH based on the rate matching.

The transmitter 845 may transmit signals generated by other components of the device 805. In some examples, the transmitter 845 may be collocated with a receiver 810 in a transceiver component. For example, the transmitter 845 may be an example of aspects of the transceiver 1020 described with reference to FIG. 10. The transmitter 845 may utilize a single antenna or a set of antennas.

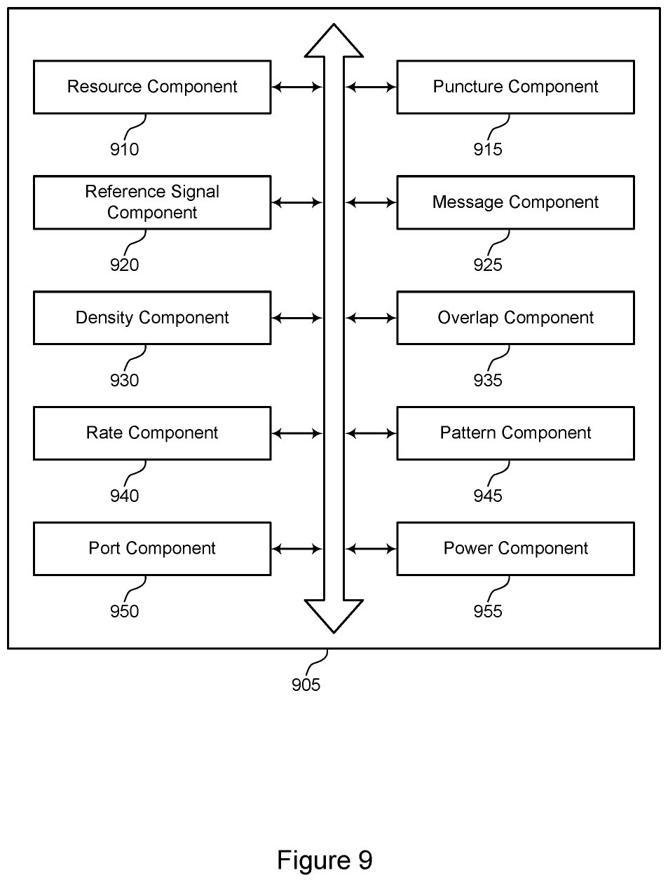

FIG. 9 shows a block diagram of a UE communications manager 905 that supports PTRS alignment for a physical shared channel in accordance with aspects of the present disclosure. The UE communications manager 905 may include a resource component 910, a puncture component 915, a reference signal component 920, a message component 925, a density component 930, an overlap component 935, a rate component 940, a pattern component 945, a port component 950, and a power component 955. Each of these components may communicate, directly or indirectly, with one another (for example, via one or more buses).

The resource component 910 may determine that one or more resource elements associated with a PTRS transmission on a first scheduled PUSCH are multiplexed with one or more resource elements associated with a data transmission on a second scheduled PUSCH. In some examples, the resource component 910 may determine one or more resources associated with a PTRS transmission on a scheduled PUSCH. The one or more resources include resource elements, resource blocks, symbols, or slots. The one or more resources include one or more periodic resources.

The puncture component 915 may puncture the one or more resource elements associated with the data transmission on the second scheduled PUSCH based on the determining. The reference signal component 920 may transmit the PTRS transmission on the first scheduled PUSCH based on puncturing the one or more resource elements associated with the data transmission on the second scheduled PUSCH. In some examples, the reference signal component 920 may transmit the PTRS transmission on the scheduled PUSCH based on the rate matching. In some examples, the reference signal component 920 may determine to refrain from a second PTRS transmission on the scheduled PUSCH based on the indication. In some examples, the reference signal component 920 may power boost the PTRS transmission on the scheduled PUSCH based on determining to refrain from the second PTRS transmission on the scheduled PUSCH.

The message component 925 may receive an indication to rate match the one or more resources associated with the PTRS transmission. In some examples, the message component 925 may receive an RRC configuration message including an indication to puncture the one or more resource elements associated with the data transmission on the second scheduled PUSCH. In some examples, puncturing the one or more resource elements associated with the data transmission on the second scheduled PUSCH is based on the received RRC configuration message. In some examples, the message component 925 may determine a UE capability to puncture the one or more resource elements associated with the data transmission on the second scheduled PUSCH.

The message component 925 may transmit UE capability information including an indication of the UE capability to puncture the one or more resource elements associated with the data transmission on the second scheduled PUSCH. In some examples, puncturing the one or more resource elements associated with the data transmission on the second scheduled PUSCH is based on the transmitted UE capability information. The message component 925 may receive an RRC configuration message including the indication to rate match the one or more resources associated with the PTRS transmission. In some examples, rate matching the one or more resources associated with the PTRS transmission is based on the received RRC configuration message. The message component 925 may receive a DCI message including the indication to rate match the one or more resources associated with the PTRS transmission. In some examples, rate matching the one or more resources associated with the PTRS transmission is based on the received DCI message.

The rate component 940 may rate matching the one or more resources associated with the PTRS transmission around one or more additional resources based on the indication. The density component 930 may determine a PTRS density associated with the first scheduled PUSCH. In some examples, the density component 930 may determine that the PTRS density associated with the first scheduled PUSCH satisfies a threshold. In some examples, puncturing the one or more resource elements associated with the data transmission on the second scheduled PUSCH is based on determining that the PTRS density associated with the first scheduled PUSCH satisfies the threshold. The density component 930 may determine the PTRS density associated with the first scheduled PUSCH in a time domain or a frequency domain, or both.

The density component 930 may determine that the PTRS density in the time domain or the frequency domain, or both, is greater than the threshold. In some examples, puncturing the one or more resource elements associated with the data transmission on the second scheduled PUSCH is based on determining that the PTRS density in the time domain or the frequency domain, or both, is greater than the threshold. The density component 930 may determine that the PTRS density in the time domain or the frequency domain, or both, is less than the threshold. In some examples, puncturing the one or more resource elements associated with the data transmission on the second scheduled PUSCH is based on determining that the PTRS density in the time domain or the frequency domain, or both, is less than the threshold. The density component 930 may determine a PTRS transmission density, an offset of the one or more resources associated with the PTRS transmission, or a location of the one or more resources associated with the PTRS transmission, based on the selected PTRS transmission pattern. In some examples, rate matching the one or more resources associated with the PTRS transmission is based on the PTRS transmission density, the offset of the one or more resources associated with the PTRS transmission, or the location of the one or more resources associated with the PTRS transmission.

The overlap component 935 may determine the first scheduled PUSCH partially overlaps the second scheduled PUSCH. In some examples, puncturing the one or more resource elements associated with the data transmission on the second scheduled PUSCH is based on the first scheduled PUSCH partially overlapping the second scheduled PUSCH. The pattern component 945 may determine a set of PTRS transmission patterns based on the received RRC configuration message. In some examples, rate matching the one or more resources associated with the PTRS transmission is based on at least one PTRS transmission pattern of the set of PTRS transmission patterns. The pattern component 945 may select at least one PTRS transmission pattern of a set of PTRS transmission patterns based on the indication in the received DCI message. In some examples, rate matching the one or more resources associated with the PTRS transmission is based on the selected PTRS transmission pattern of the set of PTRS transmission patterns.

The port component 950 may determine one or more antenna ports associated with the PTRS transmission based on the indication in the received DCI message. In some examples, rate matching the one or more resources associated with the PTRS transmission is based on the one or more antenna ports associated with the PTRS transmission. The power component 955 may power boosting the PTRS transmission on the scheduled PUSCH based on rate matching the one or more resources associated with the PTRS transmission.

FIG. 10 shows a diagram of a system including a device 1005 that supports PTRS alignment for a physical shared channel in accordance with aspects of the present disclosure. The device 1005 may be an example of or include the components of device 705, device 805, or a UE 115 as described herein. The device 1005 may include components for bi-directional voice and data communications including components for transmitting and receiving communications, including a UE communications manager 1010, an I/O controller 1015, a transceiver 1020, an antenna 1025, memory 1030, and a processor 1040. These components may be in electronic communication via one or more buses (for example, bus 1045).

The UE communications manager 1010 may determine that one or more resource elements associated with a PTRS transmission on a first scheduled PUSCH are multiplexed with one or more resource elements associated with a data transmission on a second scheduled PUSCH, puncture the one or more resource elements associated with the data transmission on the second scheduled PUSCH based on the determining. The UE communications manager 1010 may transmit the PTRS transmission on the first scheduled PUSCH based on puncturing the one or more resource elements associated with the data transmission on the second scheduled PUSCH. At least one implementation may enable the UE communications manager 1010 to puncture one or more resource elements associated with a data transmission on a second scheduled PUSCH. The punctured resource elements may function as an interference mitigation for the device 1005, if one or more resource elements associated with a PTRS transmission on a first scheduled PUSCH are multiplexed or overlapping with one or more resource elements associated with the data transmission on the second scheduled PUSCH. Based on implementing the puncturing as described herein, one or more processors of the device 1005 (for example, processor(s) controlling or incorporated with the UE communications manager 1010) may experience reduce power consumption and promote high reliability and low latency wireless communications (for example, reference signal transmissions), among other benefits.

The UE communications manager 1010 may also determine one or more resources associated with a PTRS transmission on a scheduled PUSCH, receive an indication to rate match the one or more resources associated with the PTRS transmission, rate matching the one or more resources associated with the PTRS transmission around one or more additional resources based on the indication, and transmit the PTRS transmission on the scheduled PUSCH based on the rate matching. At least one implementation may enable the UE communications manager 1010 to rate match one or more resources associated with a PTRS transmission around one or more additional resources. The rate matched resource may function as an interference mitigation for the device 1005, if one or more resources associated with a PTRS transmission on a first scheduled PUSCH are multiplexed or overlapping with one or more resources associated with a data transmission on a second scheduled PUSCH. Based on implementing the rate matching as described herein, one or more processors of the device 1005 (for example, processor(s) controlling or incorporated with the UE communications manager 1010) may experience a reduction in power consumption and promote high reliability and low latency wireless communications (for example, reference signal transmissions), among other benefits.

The I/O controller 1015 may manage input and output signals for the device 1005. The I/O controller 1015 may also manage peripherals not integrated into the device 1005. The I/O controller 1015 may represent a physical connection or port to an external peripheral. In some examples, the I/O controller 1015 may utilize an operating system such as iOS®, ANDROID®, MS-DOS®, MS-WINDOWS®, OS/2®, UNIX®, LINUX®, or another known operating system. In other examples, the I/O controller 1015 may represent or interact with a modem, a keyboard, a mouse, a touchscreen, or a similar device. In some examples, the I/O controller 1015 may be implemented as part of a processor. In some examples, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas. In some examples, the device 1005 may include a single antenna 1025. However, in some examples, the device 1005 may have more than one antenna 1025, which may be capable of concurrently transmitting or receiving multiple wireless transmissions.

The memory 1030 may include RAM and ROM. The memory 1030 may store computer-readable, computer-executable code 1035 including instructions that, when executed, cause the processor 1040 to perform various functions described herein. In some examples, the memory 1030 may contain, among other things, a BIOS which may control basic hardware or software operation such as the interaction with peripheral components or devices. The code 1035 may include instructions to implement aspects of the present disclosure, including instructions to support wireless communications. The code 1035 may be stored in a non-transitory computer-readable medium such as system memory or other type of memory. In some examples, the code 1035 may not be directly executable by the processor 1040 but may cause a computer (for example, when compiled and executed) to perform functions described herein.

The processor 1040 may include an intelligent hardware device, (for example, a general-purpose processor, a DSP, a CPU, a microcontroller, an ASIC, an FPGA, a programmable logic device, a discrete gate or transistor logic component, a discrete hardware component). In some examples, the processor 1040 may be configured to operate a memory array using a memory controller. In other examples, a memory controller may be integrated into the processor 1040. The processor 1040 may be configured to execute computer-readable instructions stored in a memory (for example, the memory 1030) to cause the device 1005 to perform various functions (for example, functions or tasks supporting PTRS alignment for a physical shared channel).

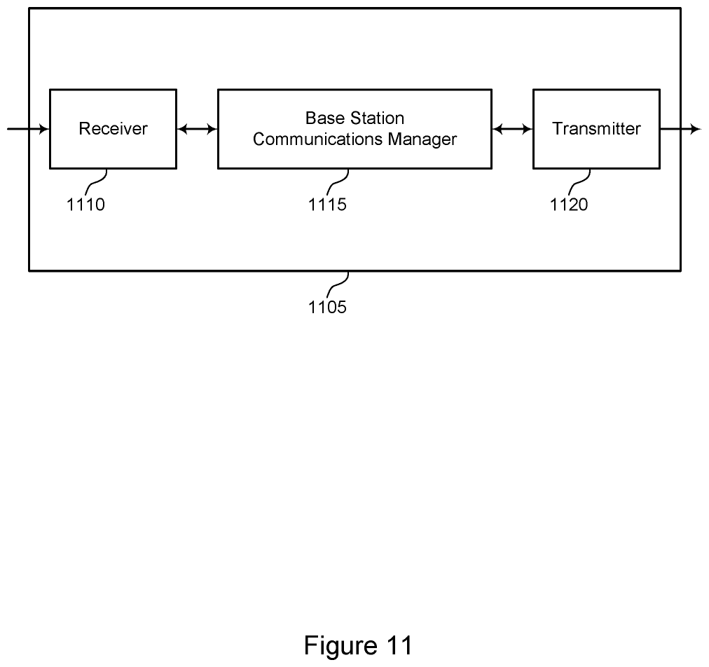

FIG. 11 shows a block diagram of a device 1105 that supports PTRS alignment for a physical shared channel in accordance with aspects of the present disclosure. The device 1105 may be an example of aspects of a base station 105 as described herein. The device 1105 may include a receiver 1110, a base station communications manager 1115, and a transmitter 1120. The base station communications manager 1115 can be implemented, at least in part, by one or both of a modem and a processor. Each of these components may be in communication with one another (for example, via one or more buses).

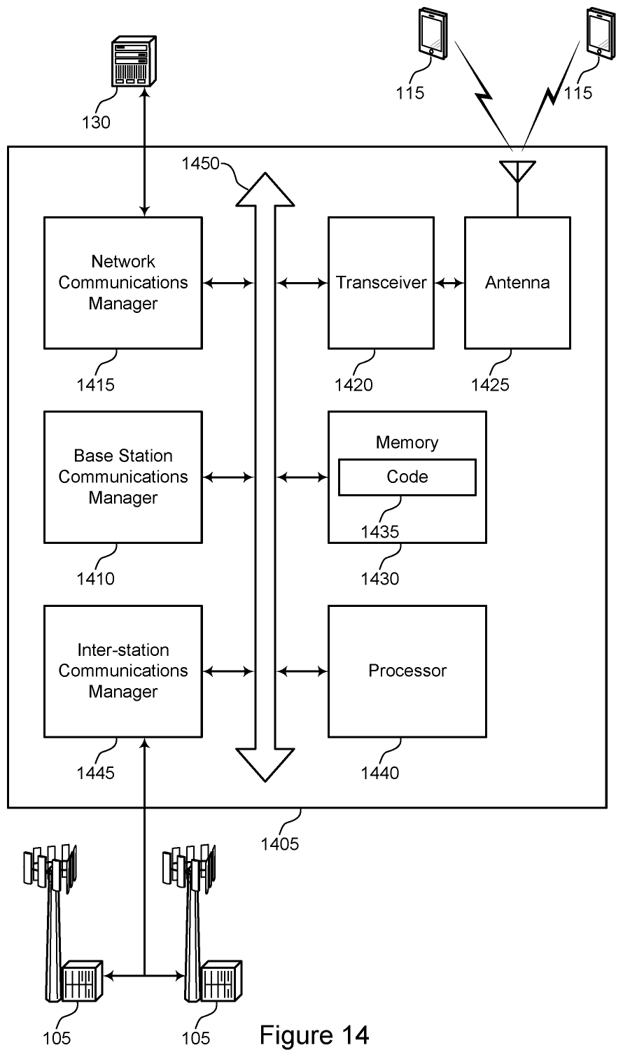

The receiver 1110 may receive information such as packets, user data, or control information associated with various information channels (for example, control channels, data channels, and information related to PTRS alignment for a physical shared channel). Information may be passed on to other components of the device 1105. The receiver 1110 may be an example of aspects of the transceiver 1420 described with reference to FIG. 14. The receiver 1110 may utilize a single antenna or a set of antennas.

The base station communications manager 1115 may transmit, to a UE a message including an indication to puncture one or more resource elements associated with a data transmission on a second scheduled PUSCH based on one or more resource elements associated with a PTRS transmission on a first scheduled PUSCH being multiplexed with the one or more resource elements associated with the data transmission on the second scheduled PUSCH and receive the PTRS transmission on the first scheduled PUSCH based on transmitting the message and the UE puncturing the one or more resource elements associated with the data transmission on the second scheduled PUSCH.

The base station communications manager 1115 may also transmit, to a UE, a message including an indication to rate match one or more resources associated with a PTRS transmission on a scheduled PUSCH around one or more additional resources and receive the PTRS transmission on the scheduled PUSCH based on transmitting the message and the UE rate matching the one or more resources associated with the PTRS transmission around the one or more additional resources.

The transmitter 1120 may transmit signals generated by other components of the device 1105. In some examples, the transmitter 1120 may be collocated with a receiver 1110 in a transceiver component. For example, the transmitter 1120 may be an example of aspects of the transceiver 1420 described with reference to FIG. 14. The transmitter 1120 may utilize a single antenna or a set of antennas.

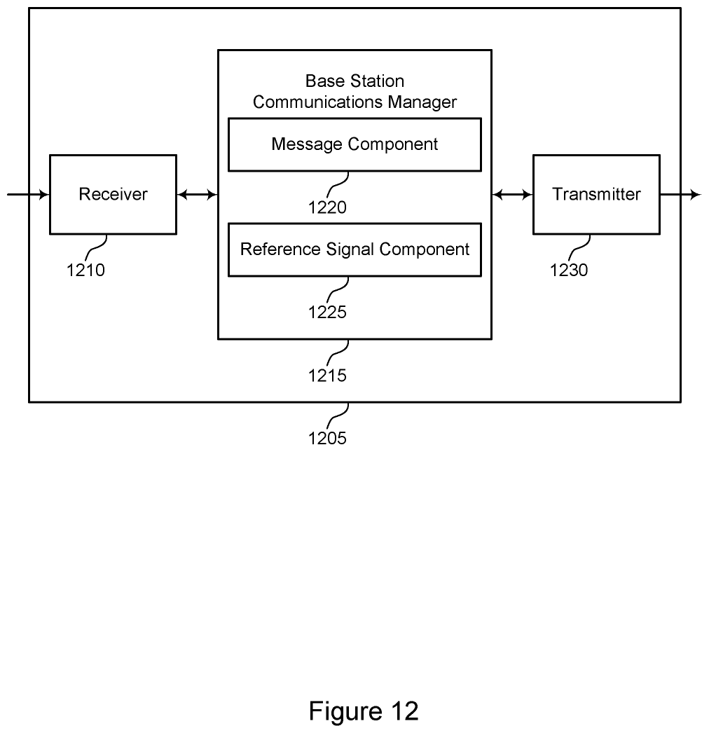

FIG. 12 shows a block diagram of a device 1205 that supports PTRS alignment for a physical shared channel in accordance with aspects of the present disclosure. The device 1205 may be an example of aspects of a device 1105, or a base station 105 as described herein. The device 1205 may include a receiver 1210, a base station communications manager 1215, and a transmitter 1230. The base station communications manager 1215 can be implemented, at least in part, by one or both of a modem and a processor. Each of these components may be in communication with one another (for example, via one or more buses).

The receiver 1210 may receive information such as packets, user data, or control information associated with various information channels (for example, control channels, data channels, and information related to PTRS alignment for a physical shared channel). Information may be passed on to other components of the device 1205. The receiver 1210 may be an example of aspects of the transceiver 1420 described with reference to FIG. 14. The receiver 1210 may utilize a single antenna or a set of antennas.

The base station communications manager 1215 may be an example of aspects of the base station communications manager 1115 as described herein. The base station communications manager 1215 may include a message component 1220 and a reference signal component 1225.

The message component 1220 may transmit, to a UE a message including an indication to puncture one or more resource elements associated with a data transmission on a second scheduled PUSCH based on one or more resource elements associated with a PTRS transmission on a first scheduled PUSCH being multiplexed with the one or more resource elements associated with the data transmission on the second scheduled PUSCH. The reference signal component 1225 may receive the PTRS transmission on the first scheduled PUSCH based on transmitting the message and the UE puncturing the one or more resource elements associated with the data transmission on the second scheduled PUSCH.

The message component 1220 may transmit, to a UE, a message including an indication to rate match one or more resources associated with a PTRS transmission on a scheduled PUSCH around one or more additional resources. The reference signal component 1225 may receive the PTRS transmission on the scheduled PUSCH based on transmitting the message and the UE rate matching the one or more resources associated with the PTRS transmission around the one or more additional resources.

The transmitter 1230 may transmit signals generated by other components of the device 1205. In some examples, the transmitter 1230 may be collocated with a receiver 1210 in a transceiver component. For example, the transmitter 1230 may be an example of aspects of the transceiver 1420 described with reference to FIG. 14. The transmitter 1230 may utilize a single antenna or a set of antennas.

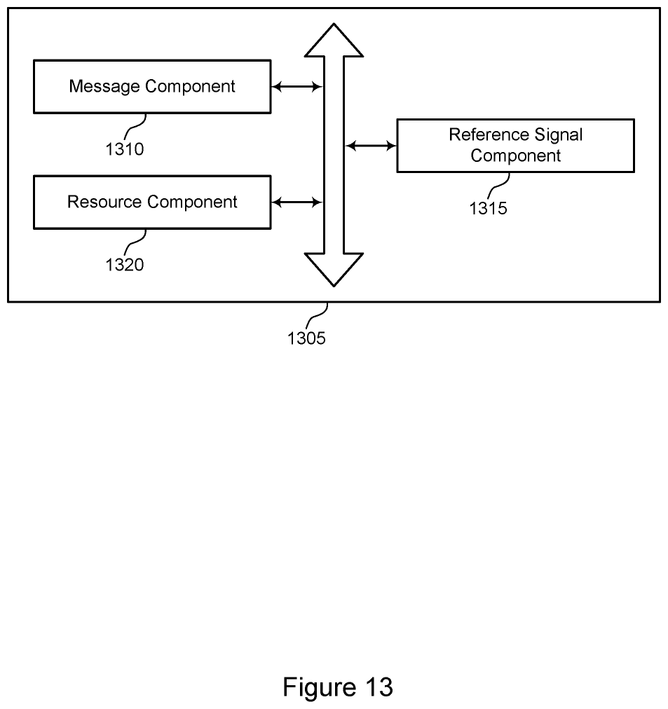

FIG. 13 shows a block diagram of a base station communications manager 1305 that supports PTRS alignment for a physical shared channel in accordance with aspects of the present disclosure. The base station communications manager 1305 may include a message component 1310, a reference signal component 1315, and a resource component 1320. Each of these components may communicate, directly or indirectly, with one another (for example, via one or more buses).

The message component 1310 may transmit, to a UE a message including an indication to puncture one or more resource elements associated with a data transmission on a second scheduled PUSCH based on one or more resource elements associated with a PTRS transmission on a first scheduled PUSCH being multiplexed with the one or more resource elements associated with the data transmission on the second scheduled PUSCH. In some examples, the message component 1310 may transmit an RRC configuration message including an indication to puncture the one or more resource elements associated with the data transmission on the second scheduled PUSCH. In some other examples, the message component 1310 may transmit a DCI message including an indication to puncture the one or more resource elements associated with the data transmission on the second scheduled PUSCH. In some examples, the message component 1310 may receive UE capability information including an indication of a UE capability to puncture the one or more resource elements associated with the data transmission on the second scheduled PUSCH, in which transmitting the message is based on the received UE capability information.

The message component 1310 may transmit, to a UE, a message including an indication to rate match one or more resources associated with a PTRS transmission on a scheduled PUSCH around one or more additional resources. In some examples, the message component 1310 may transmit an RRC configuration message including the indication to rate match the one or more resources associated with the PTRS transmission. In some examples, the message component 1310 may transmit a DCI message including the indication to rate match the one or more resources associated with the PTRS transmission. In some examples, the transmitted RRC configuration message includes a set of PTRS transmission patterns. In some examples, the transmitted DCI message includes a set of PTRS transmission patterns. In some examples, the indication includes a rate match indicator, a zero-power reference signal indicator, or a reference signal port indicator.

The reference signal component 1315 may receive the PTRS transmission on the first scheduled PUSCH based on transmitting the message and the UE puncturing the one or more resource elements associated with the data transmission on the second scheduled PUSCH. In some examples, the reference signal component 1315 may receive the PTRS transmission on the scheduled PUSCH based on transmitting the message and the UE rate matching the one or more resources associated with the PTRS transmission around the one or more additional resources. In some examples, at least one PTRS transmission pattern of a set of PTRS transmission patterns includes a PTRS transmission density, an offset of the one or more resources associated with the PTRS transmission, or a location of the one or more resources associated with the PTRS transmission. The resource component 1320 may allocate one or more resources including resource elements, resource blocks, symbols, or slots.

FIG. 14 shows a diagram of a system including a device 1405 that supports PTRS alignment for a physical shared channel in accordance with aspects of the present disclosure. The device 1405 may be an example of or include the components of device 1105, device 1205, or a base station 105 as described herein. The device 1405 may include components for bi-directional voice and data communications including components for transmitting and receiving communications, including a base station communications manager 1410, a network communications manager 1415, a transceiver 1420, an antenna 1425, memory 1430, a processor 1440, and an inter-station communications manager 1445. These components may be in electronic communication via one or more buses (for example, bus 1450).

The base station communications manager 1410 may transmit, to a UE a message including an indication to puncture one or more resource elements associated with a data transmission on a second scheduled PUSCH based on one or more resource elements associated with a PTRS transmission on a first scheduled PUSCH being multiplexed with the one or more resource elements associated with the data transmission on the second scheduled PUSCH. The base station communications manager 1410 may receive the PTRS transmission on the first scheduled PUSCH based on transmitting the message and the UE puncturing the one or more resource elements associated with the data transmission on the second scheduled PUSCH. The base station communications manager 1410 may also transmit, to a UE, a message including an indication to rate match one or more resources associated with a PTRS transmission on a scheduled PUSCH around one or more additional resources. The base station communications manager 1410 may also receive the PTRS transmission on the scheduled PUSCH based on transmitting the message and the UE rate matching the one or more resources associated with the PTRS transmission around the one or more additional resources.

The network communications manager 1415 may manage communications with the core network (for example, via one or more wired backhaul links). For example, the network communications manager 1415 may manage the transfer of data communications for client devices, such as one or more UEs 115.

The transceiver 1420 may communicate bi-directionally, via one or more antennas, wired, or wireless links as described above. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas. In some examples, the device 1405 may have more than one antenna 1425, which may be capable of concurrently transmitting or receiving multiple wireless transmissions.

The memory 1430 may include RAM, ROM, or a combination thereof. The memory 1430 may store computer-readable code 1435 including instructions that, when executed by a processor (for example, the processor 1440) cause the device to perform various functions described herein. In some examples, the memory 1430 may contain, among other things, a BIOS which may control basic hardware or software operation such as the interaction with peripheral components or devices. The code 1435 may include instructions to implement aspects of the present disclosure, including instructions to support wireless communications. The code 1435 may be stored in a non-transitory computer-readable medium such as system memory or other type of memory. In some examples, the code 1435 may not be directly executable by the processor 1440 but may cause a computer (for example, when compiled and executed) to perform functions described herein.

The processor 1440 may include an intelligent hardware device, (for example, a general-purpose processor, a DSP, a CPU, a microcontroller, an ASIC, an FPGA, a programmable logic device, a discrete gate or transistor logic component, a discrete hardware component). In some examples, the processor 1440 may be configured to operate a memory array using a memory controller. In some examples, a memory controller may be integrated into processor 1440. The processor 1440 may be configured to execute computer-readable instructions stored in a memory (for example, the memory 1430) to cause the device 1405 to perform various functions (for example, functions or tasks supporting PTRS alignment for a physical shared channel).

The inter-station communications manager 1445 may manage communications with other base station 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communication network technology to provide communication between base stations 105.

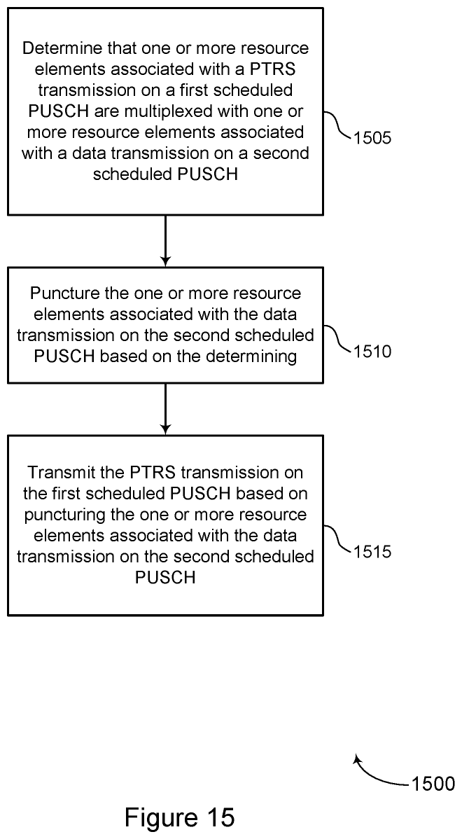

FIG. 15 shows a flowchart illustrating a method 1500 that supports PTRS alignment for a physical shared channel in accordance with aspects of the present disclosure. The operations of method 1500 may be implemented by a UE 115 or its components as described herein. For example, the operations of method 1500 may be performed by a UE communications manager as described with reference to FIGS. 7-10. In some examples, a UE may execute a set of instructions to control the functional elements of the UE to perform the functions described below. Additionally or alternatively, a UE may perform aspects of the functions described below using special-purpose hardware.

At 1505, the UE may determine that one or more resource elements associated with a PTRS transmission on a first scheduled PUSCH are multiplexed with one or more resource elements associated with a data transmission on a second scheduled PUSCH. The operations of 1505 may be performed according to the methods described herein. In some examples, aspects of the operations of 1505 may be performed by a resource component as described with reference to FIGS. 7-10.

At 1510, the UE may puncture the one or more resource elements associated with the data transmission on the second scheduled PUSCH based on the determining. The operations of 1510 may be performed according to the methods described herein. In some examples, aspects of the operations of 1510 may be performed by a puncture component as described with reference to FIGS. 7-10.

At 1515, the UE may transmit the PTRS transmission on the first scheduled PUSCH based on puncturing the one or more resource elements associated with the data transmission on the second scheduled PUSCH. The operations of 1515 may be performed according to the methods described herein. In some examples, aspects of the operations of 1515 may be performed by a reference signal component as described with reference to FIGS. 7-10.

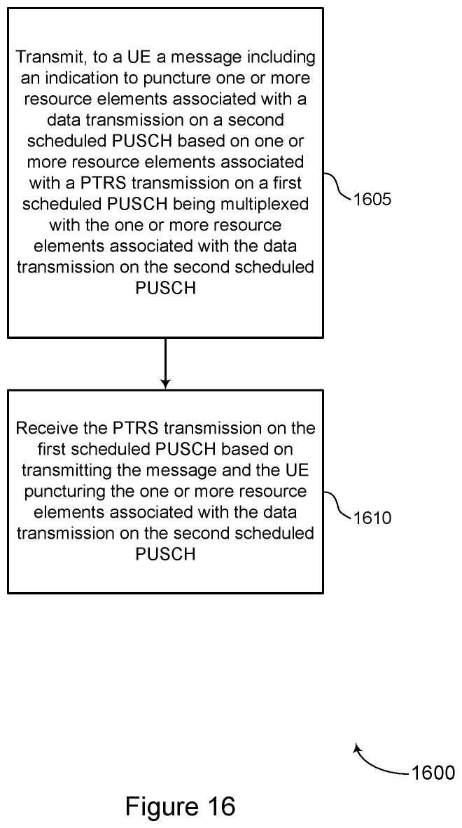

FIG. 16 shows a flowchart illustrating a method 1600 that supports PTRS alignment for a physical shared channel in accordance with aspects of the present disclosure. The operations of method 1600 may be implemented by a base station 105 or its components as described herein. For example, the operations of method 1600 may be performed by a base station communications manager as described with reference to FIGS. 11-14. In some examples, a base station may execute a set of instructions to control the functional elements of the base station to perform the functions described below. Additionally or alternatively, a base station may perform aspects of the functions described below using special-purpose hardware.

At 1605, the base station may transmit, to a UE a message including an indication to puncture one or more resource elements associated with a data transmission on a second scheduled PUSCH based on one or more resource elements associated with a PTRS transmission on a first scheduled PUSCH being multiplexed with the one or more resource elements associated with the data transmission on the second scheduled PUSCH. The operations of 1605 may be performed according to the methods described herein. In some examples, aspects of the operations of 1605 may be performed by a message component as described with reference to FIGS. 11-14.

At 1610, the base station may receive the PTRS transmission on the first scheduled PUSCH based on transmitting the message and the UE puncturing the one or more resource elements associated with the data transmission on the second scheduled PUSCH. The operations of 1610 may be performed according to the methods described herein. In some examples, aspects of the operations of 1610 may be performed by a reference signal component as described with reference to FIGS. 11-14.

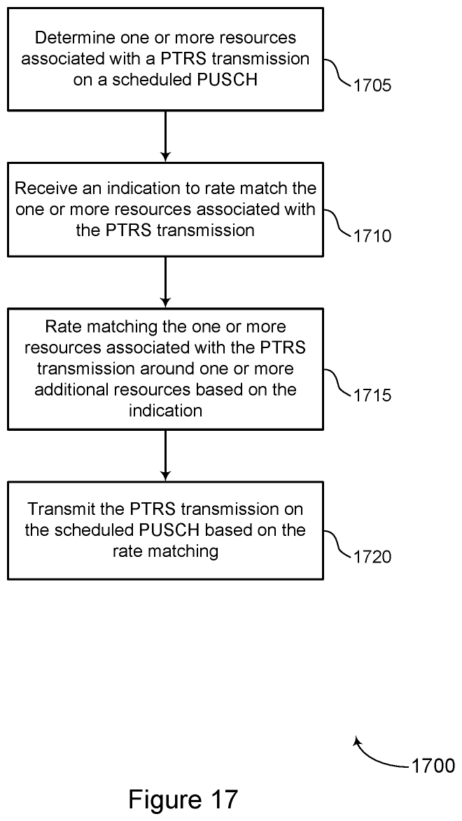

FIG. 17 shows a flowchart illustrating a method 1700 that supports PTRS alignment for a physical shared channel in accordance with aspects of the present disclosure. The operations of method 1700 may be implemented by a UE 115 or its components as described herein. For example, the operations of method 1700 may be performed by a UE communications manager as described with reference to FIGS. 7-10. In some examples, a UE may execute a set of instructions to control the functional elements of the UE to perform the functions described below. Additionally or alternatively, a UE may perform aspects of the functions described below using special-purpose hardware.

At 1705, the UE may determine one or more resources associated with a PTRS transmission on a scheduled PUSCH. The operations of 1705 may be performed according to the methods described herein. In some examples, aspects of the operations of 1705 may be performed by a resource component as described with reference to FIGS. 7-10.

At 1710, the UE may receive an indication to rate match the one or more resources associated with the PTRS transmission. The operations of 1710 may be performed according to the methods described herein. In some examples, aspects of the operations of 1710 may be performed by a message component as described with reference to FIGS. 7-10.

At 1715, the UE may rate matching the one or more resources associated with the PTRS transmission around one or more additional resources based on the indication. The operations of 1715 may be performed according to the methods described herein. In some examples, aspects of the operations of 1715 may be performed by a rate component as described with reference to FIGS. 7-10.

At 1720, the UE may transmit the PTRS transmission on the scheduled PUSCH based on the rate matching. The operations of 1720 may be performed according to the methods described herein. In some examples, aspects of the operations of 1720 may be performed by a reference signal component as described with reference to FIGS. 7-10.

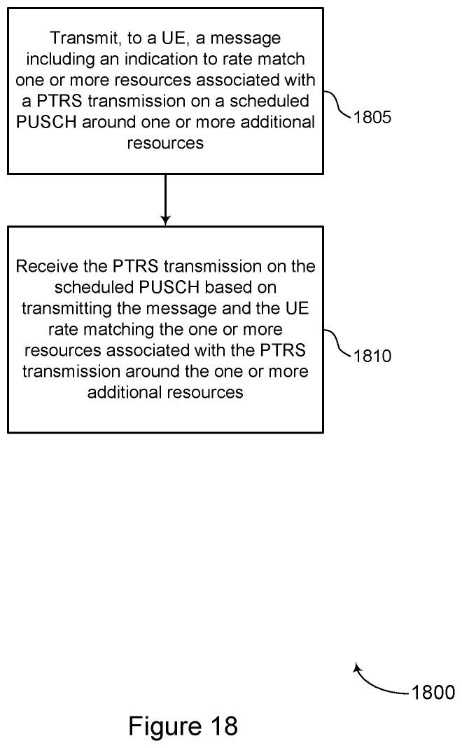

FIG. 18 shows a flowchart illustrating a method 1800 that supports PTRS alignment for a physical shared channel in accordance with aspects of the present disclosure. The operations of method 1800 may be implemented by a base station 105 or its components as described herein. For example, the operations of method 1800 may be performed by a base station communications manager as described with reference to FIGS. 11-14. In some examples, a base station may execute a set of instructions to control the functional elements of the base station to perform the functions described below. Additionally or alternatively, a base station may perform aspects of the functions described below using special-purpose hardware.

At 1805, the base station may transmit, to a UE, a message including an indication to rate match one or more resources associated with a PTRS transmission on a scheduled PUSCH around one or more additional resources. The operations of 1805 may be performed according to the methods described herein. In some examples, aspects of the operations of 1805 may be performed by a message component as described with reference to FIGS. 11-14.

At 1810, the base station may receive the PTRS transmission on the scheduled PUSCH based on transmitting the message and the UE rate matching the one or more resources associated with the PTRS transmission around the one or more additional resources. The operations of 1810 may be performed according to the methods described herein. In some examples, aspects of the operations of 1810 may be performed by a reference signal component as described with reference to FIGS. 11-14.

It is noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, or optical fields or particles.

The various illustrative blocks and components described in connection with the disclosure herein may be implemented or performed with a general-purpose processor, a DSP, an ASIC, a CPU, an FPGA or other programmable logic device, discrete gate or transistor logic, or discrete hardware components, designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor or firmware. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc in which disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (for example, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a user equipment (UE), comprising:
determining that one or more resource elements associated with a phase tracking reference signal transmission on a first scheduled physical uplink shared channel are multiplexed with one or more resource elements associated with a data transmission on a second scheduled physical uplink shared channel;
puncturing the one or more resource elements associated with the data transmission on the second scheduled physical uplink shared channel based at least in part on the determining; and
transmitting the phase tracking reference signal transmission on the first scheduled physical uplink shared channel based at least in part on puncturing the one or more resource elements associated with the data transmission on the second scheduled physical uplink shared channel.

2. The method of claim 1, further comprising:
receiving a radio resource control configuration message comprising an indication to puncture the one or more resource elements associated with the data transmission on the second scheduled physical uplink shared channel, wherein puncturing the one or more resource elements associated with the data transmission on the second scheduled physical uplink shared channel is based at least in part on the received radio resource control configuration message.

3. The method of claim 1 or 2, further comprising:
determining a UE capability to puncture the one or more resource elements associated with the data transmission on the second scheduled physical uplink shared channel; and
transmitting UE capability information comprising an indication of the UE capability to puncture the one or more resource elements associated with the data transmission on the second scheduled physical uplink shared channel, wherein puncturing the one or more resource elements associated with the data transmission on the second scheduled physical uplink shared channel is based at least in part on the transmitted UE capability information.

4. The method of any of claims 1-3, further comprising:
determining a phase tracking reference signal density associated with the first scheduled physical uplink shared channel in a time domain or a frequency domain, or both; and
determining that the phase tracking reference signal density associated with the first scheduled physical uplink shared channel satisfies a threshold, wherein puncturing the one or more resource elements associated with the data transmission on the second scheduled physical uplink shared channel is based at least in part on determining that the phase tracking reference signal density associated with the first scheduled physical uplink shared channel satisfies the threshold.

5. The method of claim 4, further comprising determining that the phase tracking reference signal density in the time domain or the frequency domain, or both, is greater or less than the threshold, wherein puncturing the one or more resource elements associated with the data transmission on the second scheduled physical uplink shared channel is based at least in part on determining that the phase tracking reference signal density in the time domain or the frequency domain, or both; is greater or less than the threshold.

6. The method of any of claims further comprising determining the first scheduled physical uplink shared channel partially overlaps the second scheduled physical uplink shared channel, wherein puncturing the one or more resource elements associated with the data transmission on the second scheduled physical uplink shared channel is based at least in part on the first scheduled physical uplink shared channel partially overlapping the second scheduled physical uplink shared channel.

7. A method for wireless communication at a base station, comprising:
transmitting, to a user equipment (UE) a message comprising an indication to puncture one or more resource elements associated with a data transmission on a second scheduled physical uplink shared channel based at least in part on one or more resource elements associated with a phase tracking reference signal transmission on a first scheduled physical uplink shared channel being multiplexed with the one or more resource elements associated with the data transmission on the second scheduled physical uplink shared channel; and
receiving the phase tracking reference signal transmission on the first scheduled physical uplink shared channel based at least in part on transmitting the message and the UE puncturing the one or more resource elements associated with the data transmission on the second scheduled physical uplink shared channel.

8. The method of claim 7, wherein transmitting the message comprises transmitting one or both of a radio resource control configuration message or a downlink control information message comprising an indication to puncture the one or more resource elements associated with the data transmission on the second scheduled physical uplink shared channel.

9. The method of any of claims 7-8, further comprising receiving UE capability information comprising an indication of a UE capability to puncture the one or more resource elements associated with the data transmission on the second scheduled physical uplink shared channel, wherein transmitting the message is based at least in part on the received UE capability information.

10. A method for wireless communication at a user equipment (UE), comprising:
determining one or more resources associated with a phase tracking reference signal transmission on a scheduled physical uplink shared channel;
receiving an indication to rate match the one or more resources associated with the phase tracking reference signal transmission;
rate matching the one or more resources associated with the phase tracking reference signal transmission around one or more additional resources based at least in part on the indication; and
transmitting the phase tracking reference signal transmission on the scheduled physical uplink shared channel based at least in part on the rate matching.

11. The method of claim 10, wherein receiving the indication comprises receiving a radio resource control configuration message comprising the indication to rate match the one or more resources associated with the phase tracking reference signal transmission, wherein rate matching the one or more resources associated with the phase tracking reference signal transmission is based at least in part on the received radio resource control configuration message.

12. The method of claim 11, further comprising determining a set of phase tracking reference signal transmission patterns based at least in part on the received radio resource control configuration message, wherein rate matching the one or more resources associated with the phase tracking reference signal transmission is based at least in part on at least one phase tracking reference signal transmission pattern of the set of phase tracking reference signal transmission patterns.

13. The method of any of claims 10-12, wherein receiving the indication comprises receiving a downlink control information message comprising the indication to rate match the one or more resources associated with the phase tracking reference signal transmission, wherein rate matching the one or more resources associated with the phase tracking reference signal transmission is based at least in part on the received downlink control information message.

14. The method of claim 13, further comprising selecting at least one phase tracking reference signal transmission pattern of a set of phase tracking reference signal transmission patterns based at least in part on the indication in the received downlink control information message, wherein rate matching the one or more resources associated with the phase tracking reference signal transmission is based at least in part on the selected phase tracking reference signal transmission pattern of the set of phase tracking reference signal transmission patterns.

15. The method of claim 14, further comprising determining one or more of a phase tracking reference signal transmission density, an offset of the one or more resources associated with the phase tracking reference signal transmission, or a location of the one or more resources associated with the phase tracking reference signal transmission, based at least in part on the selected phase tracking reference signal transmission pattern, wherein rate matching the one or more resources associated with the phase tracking reference signal transmission is based at least in part on one or more of the phase tracking reference signal transmission density, the offset of the one or more resources associated with the phase tracking reference signal transmission, or the location of the one or more resources associated with the phase tracking reference signal transmission.

16. The method of claim 15, further comprising determining one or more antenna ports associated with the phase tracking reference signal transmission based at least in part on the indication in the received downlink control information message, wherein rate matching the one or more resources associated with the phase tracking reference signal transmission is based at least in part on the one or more antenna ports associated with the phase tracking reference signal transmission.

17. The method of any of claims 10-16, further comprising power boosting the phase tracking reference signal transmission on the scheduled physical uplink shared channel based at least in part on rate matching the one or more resources associated with the phase tracking reference signal transmission.

18. The method of claim 17, further comprising determining to refrain from a second phase tracking reference signal transmission on the scheduled physical uplink shared channel based at least in part on the indication, wherein power boosting the phase tracking reference signal transmission on the scheduled physical uplink shared channel is based at least in part on determining to refrain from the second phase tracking reference signal transmission on the scheduled physical uplink shared channel.

19. The method of any of claims 10-18, wherein the one or more resources comprise one or more periodic resources.

20. A method for wireless communication at a base station, comprising:
transmitting, to a user equipment (UE), a message comprising an indication to rate match one or more resources associated with a phase tracking reference signal transmission on a scheduled physical uplink shared channel around one or more additional resources; and
receiving the phase tracking reference signal transmission on the scheduled physical uplink shared channel based at least in part on transmitting the message and the UE rate matching the one or more resources associated with the phase tracking reference signal transmission around the one or more additional resources.

21. The method of claim 20, wherein transmitting the message comprises transmitting one or both of a radio resource control configuration message or a downlink control information message comprising the indication to rate match the one or more resources associated with the phase tracking reference signal transmission.

22. The method of claim 21, wherein one or both of the transmitted radio resource control configuration message or the transmitted downlink control information message comprises a set of phase tracking reference signal transmission patterns.

23. The method of any of claims 20-22, wherein transmitting the message comprises transmitting a downlink control information message comprising the indication to rate match the one or more resources associated with the phase tracking reference signal transmission.

24. The method of claim 23, wherein the transmitted downlink control information message comprises a set of phase tracking reference signal transmission patterns.

25. The method of claim 23, wherein at least one phase tracking reference signal transmission pattern of a set of phase tracking reference signal transmission patterns comprises one or more of a phase tracking reference signal transmission density, an offset of the one or more resources associated with the phase tracking reference signal transmission, or a location of the one or more resources associated with the phase tracking reference signal transmission.

26. The method of any of claims 20-25, wherein the indication comprises a rate match indicator, a zero-power reference signal indicator, or a reference signal port indicator.

27. The method of any of claims 20-26, wherein the one or more resources comprise one or more of resource elements, resource blocks, symbols, or slots.

28. An apparatus for wireless communication, comprising:
a processor,
memory coupled with the processor; and
instructions stored in the memory and executable by the processor to cause the apparatus to:
determine that one or more resource elements associated with a phase tracking reference signal transmission on a first scheduled physical uplink shared channel are multiplexed with one or more resource elements associated with a data transmission on a second scheduled physical uplink shared channel;
puncture the one or more resource elements associated with the data transmission on the second scheduled physical uplink shared channel based at least in part on the determining; and
transmit the phase tracking reference signal transmission on the first scheduled physical uplink shared channel based at least in part on puncturing the one or more resource elements associated with the data transmission on the second scheduled physical uplink shared channel.

29. The apparatus of claim 28, wherein the instructions are further executable by the processor to cause the apparatus to receive a radio resource control configuration message comprising an indication to puncture the one or more resource elements associated with the data transmission on the second scheduled physical uplink shared channel, wherein puncturing the one or more resource elements associated with the data transmission on the second scheduled physical uplink shared channel is based at least in part on the received radio resource control configuration message.

30. The apparatus of claim 28 or 29, wherein the instructions are further executable by the processor to cause the apparatus to:
determine a UE capability to puncture the one or more resource elements associated with the data transmission on the second scheduled physical uplink shared channel; and
transmit UE capability information comprising an indication of the UE capability to puncture the one or more resource elements associated with the data transmission on the second scheduled physical uplink shared channel, wherein puncturing the one or more resource elements associated with the data transmission on the second scheduled physical uplink shared channel is based at least in part on the transmitted UE capability information.

31. The apparatus of any of claims 28-30, wherein the instructions are further executable by the processor to cause the apparatus to:
determine a phase tracking reference signal density associated with the first scheduled physical uplink shared channel; and
determine that the phase tracking reference signal density associated with the first scheduled physical uplink shared channel satisfies a threshold, wherein puncturing the one or more resource elements associated with the data transmission on the second scheduled physical uplink shared channel is based at least in part on determining that the phase tracking reference signal density associated with the first scheduled physical uplink shared channel satisfies the threshold.

32. The apparatus of claim 31, wherein the instructions to determine the phase tracking reference signal density are executable by the processor to cause the apparatus to determine the phase tracking reference signal density associated with the first scheduled physical uplink shared channel in a time domain or a frequency domain, or both.

33. The apparatus of claim 32, wherein the instructions are further executable by the processor to cause the apparatus to determine that the phase tracking reference signal density in the time domain or the frequency domain, or both, is greater than the threshold, wherein puncturing the one or more resource elements associated with the data transmission on the second scheduled physical uplink shared channel is based at least in part on determining that the phase tracking reference signal density in the time domain or the frequency domain, or both, is greater than the threshold.

34. The apparatus of claim 32, wherein the instructions are further executable by the processor to cause the apparatus to determine that the phase tracking reference signal density in the time domain or the frequency domain, or both, is less than the threshold, wherein puncturing the one or more resource elements associated with the data transmission on the second scheduled physical uplink shared channel is based at least in part on determining that the phase tracking reference signal density in the time domain or the frequency domain, or both, is less than the threshold.

35. The apparatus of any of claims 28-34, wherein the instructions are further executable by the processor to cause the apparatus to determine the first scheduled physical uplink shared channel partially overlaps the second scheduled physical uplink shared channel, wherein puncturing the one or more resource elements associated with the data transmission on the second scheduled physical uplink shared channel is based at least in part on the first scheduled physical uplink shared channel partially overlapping the second scheduled physical uplink shared channel.
